(19) United States
(12) Patent Application Publication
(10) Pub. No.: US 2026/0039404 A1
(43) Pub. Date: Feb. 5, 2026

(54) METHODS FOR CLI-BASED DYNAMIC GUARD-BAND ADAPTATION

(71) Applicant: INTERDIGITAL PATENT HOLDINGS, INC., Wilmington, DE (US)

(72) Inventors: Jonghyun Park, Syosset, NY (US); Moon IL Lee, Melville, NY (US); Aata El Hamss, Laval (CA); Nazli Khan Beigi, Longueuil (CA); Virgile Garcia, Antibes (FR)

(73) Assignee: INTERDIGITAL PATENT HOLDINGS, INC., Wilmington, DE (US)

(21) Appl. No.: 18/794,813

(22) Filed: Aug. 5, 2024

(51) Int. Cl. H04B 17/345; H04L 5/14; H04W 72/21

(52) U.S. Cl. CPC H04B 17/345; H04L 5/14; H04W 72/21

(57) ABSTRACT

A system and method performed in a wireless transmit/receive unit (WTRU) are described. The method includes receiving a duplexing sub-band full duplex (SBFD) configuration information from a serving cell, the SBFD configuration information including a guard-band configuration associated with cross link interference (CLI) measurements, and a CLI threshold, determining that a measured CLI exceeds the CLI threshold, based on the determination that the measured CLI exceeds the CLI threshold, determining a set of resource blocks (RBs) to use as a first guard-band, performing an uplink (UL) transmission with the first guard-band by puncturing the determined set of RBs, wherein the UL transmission comprises reporting information on at least one of the punctured determined set of RBs used as the first guard band and the measured CLI, and receiving an indication from a network acknowledging the reporting information.

### BACKGROUND

New Radio (NR) duplex operation may provide a foundation in improving conventional time division duplex (TDD) operation by enhancing UL coverage, improving capacity, reducing latency, and so forth. The conventional TDD is based on splitting the time domain between the uplink and downlink. Full duplex, or more specifically, sub-band non-overlapping full duplex (SBFD) at the gNB within a conventional TDD band may be used. The SBFD configuration is static and is expected to be the same across different neighboring cells. As development continues, dynamic configuration of SBFD may occur. This dynamic configuration may, for example, allow dynamic changes of configuration for each cell and/or WTRU specific configuration using flexible SBFD slots/symbols.

### SUMMARY

A system and method performed in a wireless transmit/receive unit (WTRU) are described. The method includes receiving a duplexing sub-band full duplex (SBFD) configuration information from a serving cell, the SBFD configuration information including a guard-band configuration associated with cross link interference (CLI) measurements, and a CLI threshold, determining that a measured CLI exceeds the CLI threshold, based on the determination that the measured CLI exceeds the CLI threshold, determining a set of resource blocks (RBs) to use as a first guard-band, performing an uplink (UL) transmission with the first guard-band by puncturing the determined set of RBs, wherein the UL transmission comprises reporting information on at least one of the punctured determined set of RBs used as the first guard band and the measured CLI, and receiving an indication from a network acknowledging the reporting information. The SBFD configuration information may be based on a capability of the WTRU. The SBFD configuration information may further include CLI measurement configuration information and a reporting configuration. The guard-band configuration associated with CLI measurements may include a trigger associated with the CLI threshold. The guard-band configuration associated with CLI measurements may include a guard-band granularity value. The guard-band configuration associated with CLI measurements may include an indication to perform partial transmissions overlapping the set of RBs to use as the first guard-band. The method may further include receiving a resource allocation for transmissions. The resource allocation for transmission may include an UL periodic/configured grant. The UL periodic/configured grant may include at least one of radio resource control (RRC) reconfiguration, medium access control (MAC) control element (CE) activation, or downlink control information (DCI). The determining a set of RBs to use as the first guard-band may include a size and a position of the first guard-band corresponding to one or more RBs of the set of RBs exceeding the CLI threshold. The receiving an indication from the network acknowledging the reported information may include an updated SBFD sub-band configuration. The updated SBFD sub-band configuration may include a second guard-band. The updated SBFD configuration may be received via one of a MAC CE or a DCI message.

A wireless transmit receive unit (WTRU) is also described. The WTRU includes a processor and a transceiver operably coupled to the processor. The processor and the transceiver operate to receive a duplexing sub-band full duplex (SBFD) configuration information from a serving cell, the SBFD configuration information including a guard-band configuration associated with cross link interference (CLI) measurements, and a CLI threshold, determine that a measured CLI exceeds the CLI threshold, based on the determination that the measured CLI exceeds the CLI threshold, determine a set of resource blocks (RBs) to use as a first guard-band, perform an uplink (UL) transmission with the first guard-band by puncturing the determined set of RBs, wherein the UL transmission comprises reporting information on at least one of the punctured determined set of RBs used as the first guard band and the measured CLI, and receive an indication from a network acknowledging the reporting information. The SBFD configuration information may based on a capability of the WTRU and may include CLI measurement configuration information and a reporting configuration. The guard-band configuration associated with CLI measurements may include at least one of a trigger associated with the CLI threshold, a guard-band granularity value, and an indication to perform partial transmissions overlapping the set of RBs to use as a first guard-band. The processor and the transceiver may further operate to receive a resource allocation for transmissions. The resource allocation for transmissions may include an UL periodic/configured grant method comprising at least one of radio resource control (RRC) reconfiguration, medium access control (MAC) control element (CE) activation or downlink control information (DCI). The determining a set of RBs to use as the guard-band may include a size and a position of the guard-band corresponding to one or more RBs of the set of RBs exceeding the CLI threshold. An updated SBFD sub-band configuration may include a second guard-band and is received via one of a MAC and a DCI message.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a system depicting cross link interference (CLI) for inter-gNBs and inter-WTRUs;

FIG. 3 illustrates an exemplary configuration of co-channel CLI between a serving cell and a neighboring cell with different SBFD configurations with the serving cell WTRU causing CLI at neighboring cell;

FIG. 4 illustrates an exemplary configuration of co-channel CLI between a serving cell and a neighboring cell with different SBFD configurations with the neighboring cell WTRU causing CLI to the WTRU;

FIG. 5 illustrates a method that may be performed in a WTRU;

FIG. 6 illustrates multiple configurations that may be occur in SBFD configurations;

FIG. 7 illustrates an exemplary WTRU-based configuration where the WTRU does not use overlapping resources in its UL subband;

FIG. 8 illustrates an exemplary SBFD configuration; and

FIG. 9 illustrates an exemplary WTRU-based configuration where the WTRU does not use overlapping resources in its DL subband.

### DETAILED DESCRIPTION

‘A’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Hereinafter, The term “sub-band” is used to refer to a frequency-domain resource and may be characterized by at least one of the following: a set of resource blocks (RBs), a set of resource block sets (RB sets), e.g. when a carrier has intra-cell guard bands, a set of interlaced resource blocks, a bandwidth part, or portion thereof, and a carrier, or portion thereof. For example, a sub-band may be characterized by a starting RB and number of RBs for a set of contiguous RBs within a bandwidth part. A sub-band may also be defined by the value of a frequency-domain resource allocation field and bandwidth part index.

Hereinafter, the term “XDD” is used to refer to a sub-band-wise duplex (e.g., either UL or DL being used per sub-band) and may be characterized by at least one of the following: cross division duplex (e.g., sub-band-wise FDD within a TDD band), sub-band-based full duplex (e.g., full duplex as both UL and DL are used/mixed on a symbol/slot, but either UL or DL being used per sub-band on the symbol/slot), frequency-domain multiplexing (FDM) of DL/UL transmissions within a TDD spectrum, a sub-band non-overlapping full duplex (SBFD) (e.g., non-overlapped sub-band full-duplex), a full duplex other than a same-frequency (e.g., spectrum sharing, sub-band-wise-overlapped) full duplex, and an advanced duplex method, e.g., other than (pure) TDD or FDD.

Hereinafter, the term “dynamic (/flexible) TDD” is used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, In a system employing dynamic/flexible TDD, a component carrier (CC) or a bandwidth part (BWP) may have one single type among ‘D’, ‘U’, and ‘F’ on a symbol/slot, based on an indication by a group-common (GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a WTRU-to-WTRU cross-layer interference (CLI).

The term sub-band-based full duplex (SBFD) is used to refer to a sub-band-wise duplex (e.g., either UL or DL being used per sub-band) and may be characterized by at least one of the following: cross division duplex (e.g., XDD, sub-band-wise FDD within a TDD band), sub-band-based full duplex (e.g., full duplex as both UL and DL are used/mixed on a symbol/slot, but either UL or DL being used per sub-band on the symbol/slot), frequency-domain multiplexing (FDM) of DL/UL transmissions within a TDD spectrum, a sub-band non-overlapping full duplex (SBFD) (e.g., non-overlapped sub-band full-duplex), a full duplex other than a same-frequency (e.g., spectrum sharing, sub-band-wise-overlapped) full duplex, and an advanced duplex method, e.g., other than (pure) TDD or FDD, e.g., partial in-band full duplex, sub-band overlapping full duplex, in-band full duplex (IBFD).

In the following, a property of a grant or assignment may include at least one of the following: a frequency allocation, an aspect of time allocation, such as a duration, a priority, a modulation and coding scheme, a transport block size, a number of spatial layers, a number of transport blocks, a TCI state, CRI or SRI, a number of repetitions, whether the repetition scheme is Type A or Type B, whether the grant is a configured grant type 1, type 2 or a dynamic grant, whether the assignment is a dynamic assignment or a semi-persistent scheduling (configured) assignment, a configured grant index or a semi-persistent assignment index, a periodicity of a configured grant or assignment, a channel access priority class (CAPC), and any parameter provided in a DCI, by MAC or by RRC for the scheduling the grant or assignment.

An indication by DCI may include at least one of the following: an explicit indication by a DCI field or by RNTI used to mask CRC of the PDCCH, and an implicit indication by a property such as DCI format, DCI size, Coreset or search space, Aggregation Level, first resource element of the received DCI (e.g., index of first Control Channel Element), where the mapping between the property and the value may be signaled by RRC or MAC.

A signal may be interchangeably used with one or more of following: sounding reference signal (SRS), channel state information—reference signal (CSI-RS), demodulation reference signal (DM-RS), phase tracking reference signal (PT-RS), synchronization signal block (SSB), but still consistent with this invention.

A channel may be interchangeably used with one or more of following: Physical downlink control channel (PDCCH), Physical downlink shared channel (PDSCH), Physical uplink control channel (PUCCH), Physical uplink shared channel (PUSCH), Physical random access channel (PRACH), and the like, but still consistent with this invention.

Downlink reception may be used interchangeably with Rx occasion, PDCCH, PDSCH, SSB reception, but still consistent with this invention.

Uplink transmission may be used interchangeably with Tx occasion, PUCCH, PUSCH, PRACH, SRS transmission, but still consistent with this invention.

RS may be interchangeably used with one or more of RS resource, RS resource set, RS port and RS port group, but still consistent with this invention. RS may be interchangeably used with one or more of SSB, CSI-RS, SRS and DM-RS, but still consistent with this invention.

Time instance may be interchangeably used with slot, symbol, subframe, but still consistent with this invention.

UL-only and DL-only Tx/Rx occasions may interchangeably be used with legacy TDD UL or legacy TDD DL, respectively, and still consistent with this disclosure. In an example, the legacy TDD UL/DL Tx/Rx occasions may be the cases where SBFD is not configured and/or where SBFD is disabled.

A UL signal (e.g., at least one of SRS, DMRS, PUSCH, PUCCH, PRACH, PTRS, etc.) may be used interchangeably with a UL signal or channel, or a UL channel or signal, but still consistent with this invention.

A DL signal (e.g., at least one of CSI-RS, SSB, PDSCH, PDCCH, PBCH, PTRS, etc.) may be used interchangeably with a DL signal or channel, or a DL channel or signal, but still consistent with this invention.

In performing the present system, device and methods, a WTRU may provide increased functionality. The WTRU may determine a set of resources for which to apply the dynamic guard-band (e.g. puncturing transmission) based on CLI measurement. The WTRU may determine a subset of resource from a measurement for which a threshold is beyond a threshold, subset being smaller than measurement and reporting configuration. The WTRU may trigger and report a dynamic guard-band activation based on a CLI measurement beyond a threshold. The WTRU may determine whether to apply and which method to apply for the transmissions overlapping with the dynamic guard band based on, e.g., received configuration, transmission type, overlapping resources, signal quality, QoS etc. The WTRU may receive a network confirmation or reconfiguration based on the reported dynamic guard-band activation. The WTRU may determine whether to request and wait for network confirmation to apply the dynamic guard band or to apply without confirmation, based on SBFD configuration, guard band resources and data properties. The WTRU may determine a configuration for the dynamic guard-band based on both reported guard-band activation parameter and network reconfiguration. The WTRU may determine a first configuration for the dynamic guard-band, e.g. based on measurement and dynamic guard band activation and a second configuration further based on network reconfiguration. The WTRU may determine a resource overlap between a transmission/reception assignment and the dynamic guard band based on assignment and dynamic guard-band resources. The WTRU may determine transmission/reception parameters based on assignment and dynamic guard-band configuration. The WTRU may transmit part of a transmission, based on the determined transmission parameter and whether the resources are on the dynamic guard-band or not. The WTRU may (de) activate the dynamic guard-band based on, for example, timers, network indications, second measurements or cell/beam reconfiguration. The WTRU may trigger CSI/CLI reporting based on dynamic guard-band activation, measurements and/or reception of (re)configuration of cell/SBFD/CSI/CLI. The WTRU may determine an association of CLI measurement/trigger and resources within an SBFD subband, based on received configuration. The WTRU may determine an association of CLI measurement/trigger and resources within an SBFD subband based on received SBFD configurations from serving and neighboring cells. The WTRU may receive indication from the network enabling and configuring the dynamic guard-band, based on THE WTRU capability. The WTRU may report RB-level CLI/CSI measurement capabilities and dynamic guard-band support based on its implementation/capability.

A system and method performed in a wireless transmit/receive unit (WTRU) are described. The method includes receiving a duplexing sub-band full duplex (SBFD) configuration information from a serving cell, the SBFD configuration information including a guard-band configuration associated with cross link interference (CLI) measurements, and a CLI threshold, determining that a measured CLI exceeds the CLI threshold, based on the determination that the measured CLI exceeds the CLI threshold, determining a set of resource blocks (RBs) to use as a first guard-band, performing an uplink (UL) transmission with the first guard-band by puncturing the determined set of RBs, wherein the UL transmission comprises reporting information on at least one of the punctured determined set of RBs used as the first guard band and the measured CLI, and receiving an indication from a network acknowledging the reporting information. The SBFD configuration information may be based on a capability of the WTRU. The SBFD configuration information may further include CLI measurement configuration information and a reporting configuration. The guard-band configuration associated with CLI measurements may include a trigger associated with the CLI threshold. The guard-band configuration associated with CLI measurements may include a guard-band granularity value. The guard-band configuration associated with CLI measurements may include an indication to perform partial transmissions overlapping the set of RBs to use as the first guard-band. The method may further include receiving a resource allocation for transmissions. The resource allocation for transmission may include an UL periodic/configured grant. The UL periodic/configured grant may include at least one of radio resource control (RRC) reconfiguration, medium access control (MAC) control element (CE) activation, or downlink control information (DCI). The determining a set of RBs to use as the first guard-band may include a size and a position of the first guard-band corresponding to one or more RBs of the set of RBs exceeding the CLI threshold. The receiving an indication from the network acknowledging the reported information may include an updated SBFD sub-band configuration. The updated SBFD sub-band configuration may include a second guard-band. The updated SBFD configuration may be received via one of a MAC CE or a DCI message.

A wireless transmit receive unit (WTRU) is also described. The WTRU includes a processor and a transceiver operably coupled to the processor. The processor and the transceiver operate to receive a duplexing sub-band full duplex (SBFD) configuration information from a serving cell, the SBFD configuration information including a guard-band configuration associated with cross link interference (CLI) measurements, and a CLI threshold, determine that a measured CLI exceeds the CLI threshold, based on the determination that the measured CLI exceeds the CLI threshold, determine a set of resource blocks (RBs) to use as a first guard-band, perform an uplink (UL) transmission with the first guard-band by puncturing the determined set of RBs, wherein the UL transmission comprises reporting information on at least one of the punctured determined set of RBs used as the first guard band and the measured CLI, and receive an indication from a network acknowledging the reporting information. The SBFD configuration information may based on a capability of the WTRU and may include CLI measurement configuration information and a reporting configuration. The guard-band configuration associated with CLI measurements may include at least one of a trigger associated with the CLI threshold, a guard-band granularity value, and an indication to perform partial transmissions overlapping the set of RBs to use as a first guard-band. The processor and the transceiver may further operate to receive a resource allocation for transmissions. The resource allocation for transmissions may include an UL periodic/configured grant method comprising at least one of radio resource control (RRC) reconfiguration, medium access control (MAC) control element (CE) activation or downlink control information (DCI). The determining a set of RBs to use as the guard-band may include a size and a position of the guard-band corresponding to one or more RBs of the set of RBs exceeding the CLI threshold. An updated SBFD sub-band configuration may include a second guard-band and is received via one of a MAC and a DCI message.

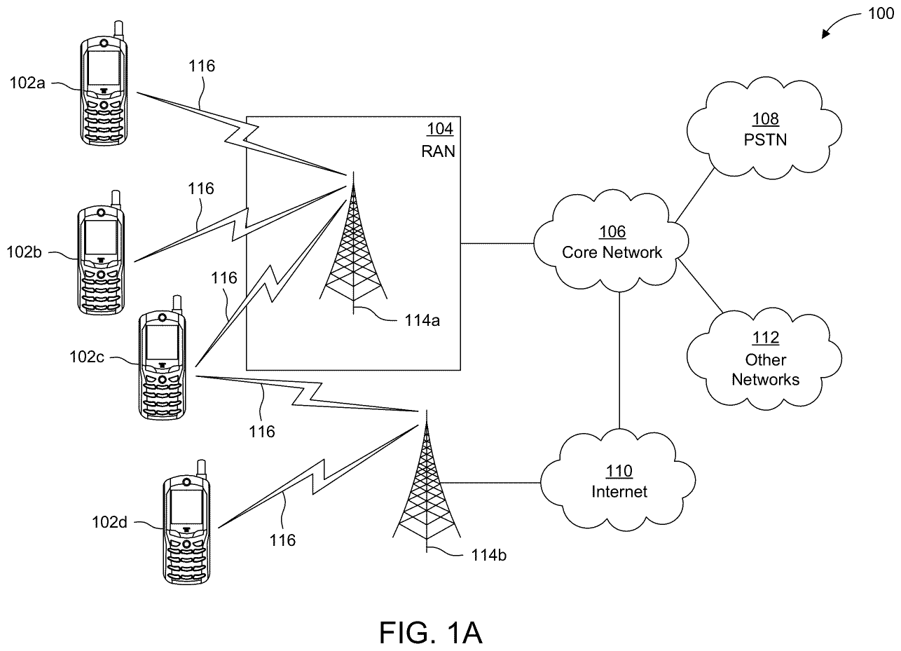

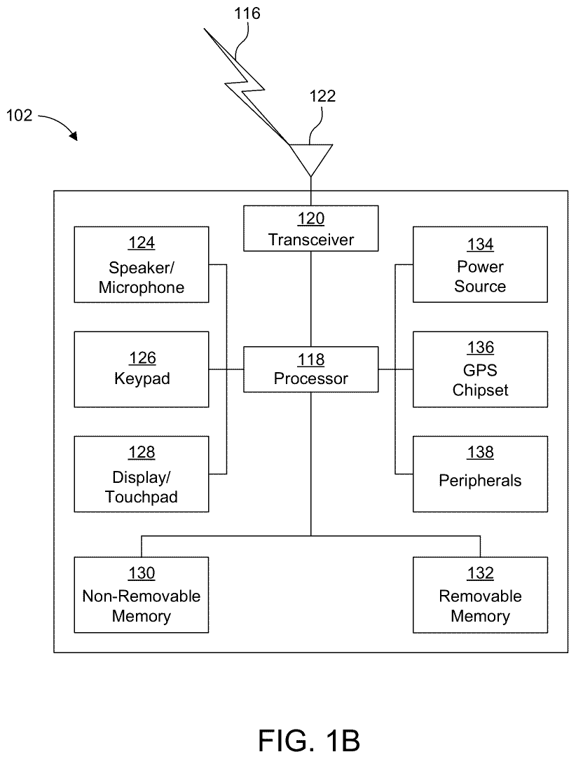

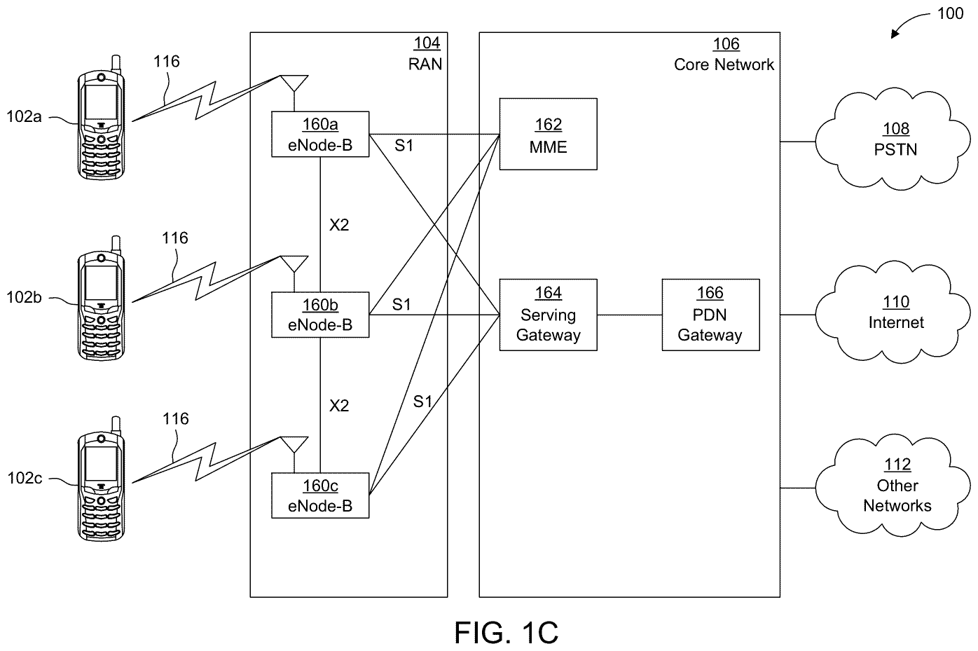

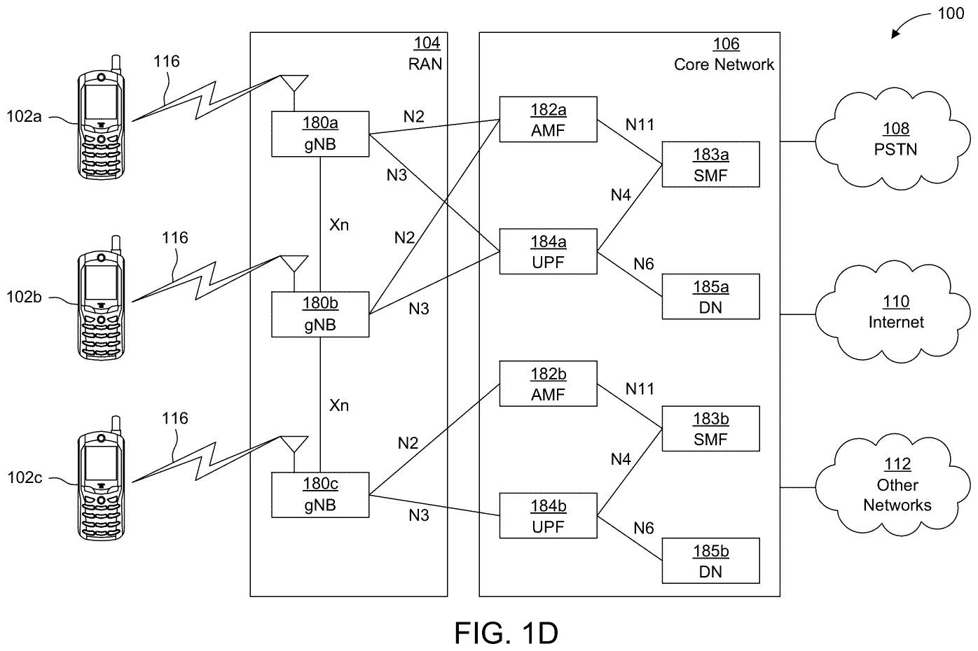

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

New Radio (NR) duplex operation may provide a foundation in improving conventional time division duplex (TDD) operation by enhancing UL coverage, improving capacity, reducing latency, and so forth. The conventional TDD is based on splitting the time domain between the uplink and downlink. Full duplex, or more specifically, sub-band non-overlapping full duplex (SBFD) at the gNB within a conventional TDD band is provided. The SBFD configuration is (semi-) static and is expected to be the same across different neighboring cells. 6G or NR future releases may introduce dynamic configuration of SBFD, e.g., by allowing dynamic changes of configuration for each cell and/or WTRU specific configuration using flexible SBFD slots/symbols.

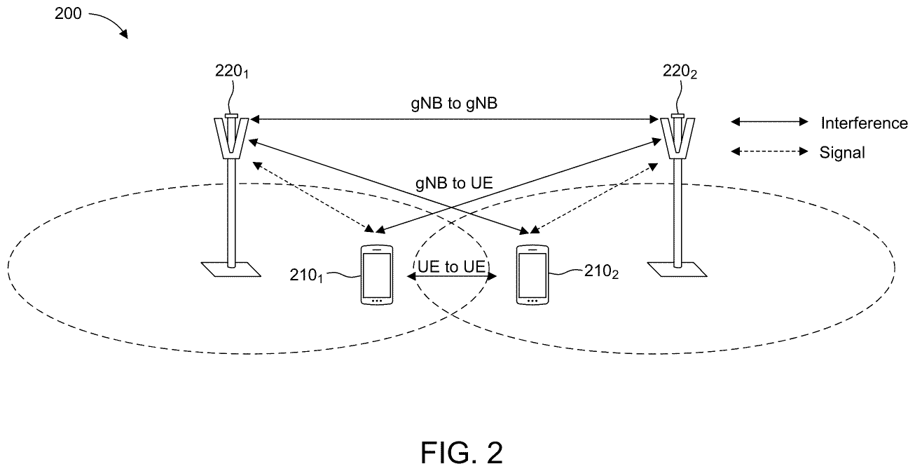

FIG. 2 illustrates a system 200 depicting cross link interference (CLI) for inter-gNBs and inter-WTRUs. As illustrated in system 200, there are two WTRUs (collectively 210) including a first WTRU 210₁ and a second WTRU 210₂. The two WTRUs 210 are connected to gNBs (collectively 220) including a first gNB 220₁ connected to WTRU 210₁ and a second gNB 220₂ connected to WTRU 210₂.Each gNB 220 has a coverage area as shown. WTRUs 210 cause CLI with each other. gNBs 220 cause CLI with each other. gNB 220₁ causes CLI with WTRU 210₂, and vice versa. gNB 220₂ causes CLI with WTRU 210₁, and vice versa. That is, for example, WTRU 210₁ receives desired signals from gNB 220₁ and receives CLI from WTRU 210₂ and gNB 220₂, WTRU 210₂ receives desired signals from gNB 220₂ and receives CLI from WTRU 210₁ and gNB 220₁, gNB 220₁ receives desired signals from WTRU 210₁ and receives CLI from gNB 220₂ and WTRU 210₂, and gNB 220₂ receives desired signals from WTRU 210₂ and receives CLI from gNB 220₁ and WTRU 210₁. The realization of SBFD is subject to resolving the key challenges raised due to CLI. The CLI can be measured at both the victim and/or aggressor WTRUs 210, as depicted in FIG. 2. For WTRUs 210, the UL-to-DL CLI happens when an UL transmission from an aggressor WTRU (for example, WTRU 210₁) causes interferences at a victim WTRU (210₂) receiving DL transmissions from gNB 220₂. WTRUs 210 may be subject to different types of UL-to-DL CLI as described below.

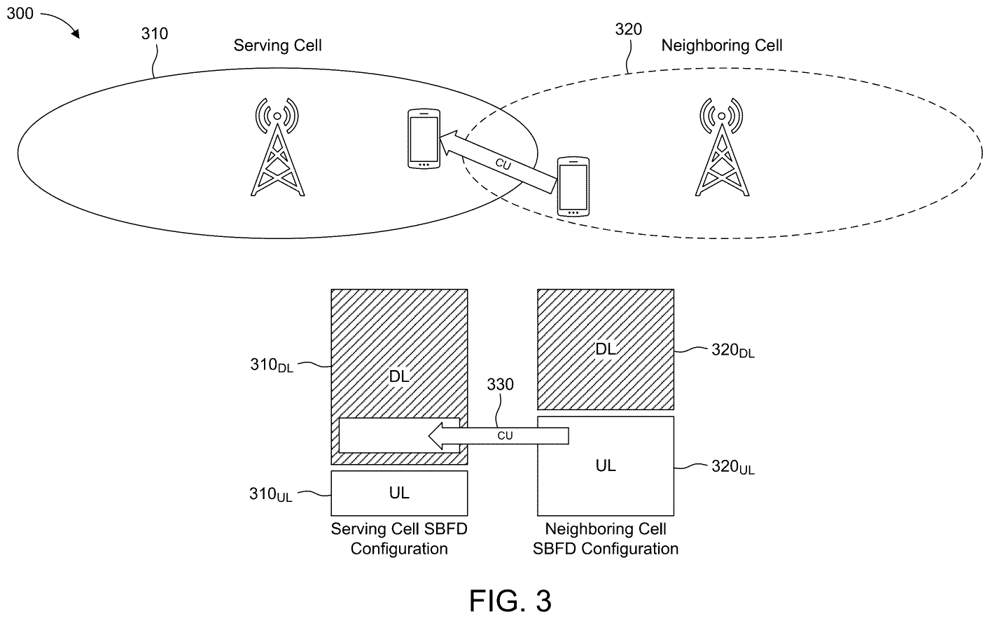

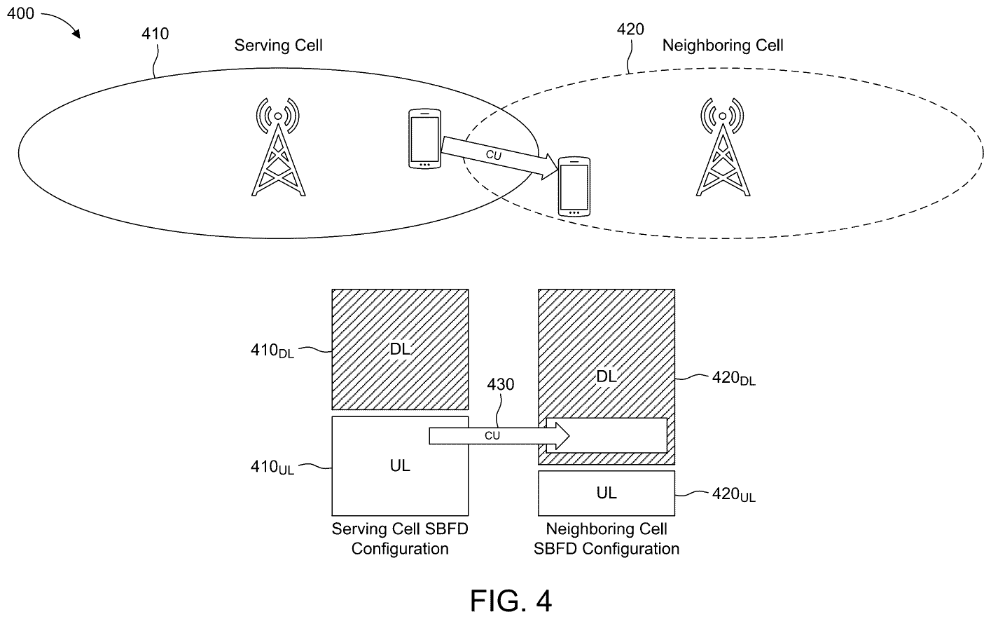

FIGS. 3 and 4 illustrate co-channel CLI between a serving cell and a neighboring cell. Intra-frequency, inter-cell (co-channel) CLI may occur when neighboring cells are configured with different link directions in the same carrier frequency, for SBFD, dynamic SBFD or dynamic/flexible TDD configurations. Intra-frequency, inter-subband CLI may occur where an UL transmission (from the serving cell or a neighboring cell) in a SBFD sub-band creates leakage interference in the adjacent DL sub-band, for the SBFD scenario. Inter-frequency CLI may occur where the UL transmission in an adjacent frequency carrier (from the serving cell or a neighboring cell) creates leakage in the adjacent DL sub-band, for both SBFD and dynamic/flexible TDD scenarios.

FIG. 3 illustrates an exemplary configuration 300 of co-channel CLI between a serving cell 310 and a neighboring cell 320 with different SBFD configurations with the serving cell WTRU causing CLI at neighboring cell. As is illustrated in FIG. 3, the serving cell 310 includes a serving cell DL 310_{DL} and a serving cell UL 310_{UL}, and the neighboring cell 320 includes a neighboring cell DL 320_{DL} and a neighboring cell UL 320_{UL}. The neighboring cell UL 320_{UL} causes CLI 330 during the serving cell DL 310_{DL}.

FIG. 4 illustrates an exemplary configuration 400 of co-channel CLI between a serving cell 410 and a neighboring cell 420 with different SBFD configurations with the neighboring cell WTRU causing CLI to the WTRU. As is illustrated in FIG. 4, the serving cell 410 includes a serving cell DL 410_{DL} and a serving cell UL 410_{UL}, and the neighboring cell 420 includes a neighboring cell DL 420_{DL} and a neighboring cell UL 420_{UL}. The neighboring cell UL 420_{UL} causes CLI 430 during the serving cell DL 410_{DL}.

In order to overcome the CLI, dynamic adaptation of SBFD sub-band configuration based on other cell duplexing settings may be used to avoid the inter-frequency cross-link interferences and the intra-frequency cross-link interferences described herein. CLI is high when neighboring cells (e.g., TRPs, nodes, gNBs) are configured with sub-bands in opposite directions that are overlapping in the frequency domain (co-channel interference). The neighboring cell configuration may not be known by the serving cell, especially when dynamic or WTRU-specific SBFD configurations are used. Even if the serving cell knows the neighboring cell configuration, the serving cell may not know which WTRUs are actually affected by the neighboring cell CLI, as it depends on the position of WTRUs and scheduling. Therefore, a system, device and method to avoid, or at least reduce, co-channel CLI when neighboring cells have different SBFD/duplexing configuration and leverage that WTRUs have identified WTRU-specific CLI situation in dynamic SBFD operation is described.

As is described in additional detail below, a WTRU may determine RBs of its SBFD sub-bands on which the WTRU does not transmit (e.g., applies puncturing) for a scheduled UL transmission based on CLI measurements. The WTRU may report to the network information on the most-recently applied “punctured RBs” and may receive feedback on whether to update the current SBFD subband configurations including guard-band position and size. Although determining RBs is used in the description to detail this and other elements of the present description, this is done to increase the understanding of the reader. As would be understood, determining a set of frequency resources may be used interchangeably with RBs, as the set of resources may include RBs, REs, PRBs, etc. That is, as described RBs is used for ease of understanding while it is understood that any set of resources may be used interchangeably with the described RBs.

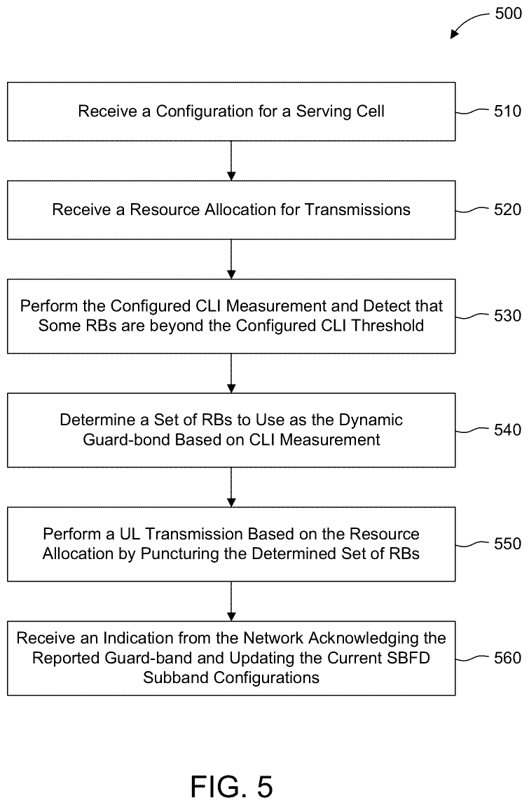

FIG. 5 illustrates a method 500 that may be performed in a WTRU. Method 500 may include, at 510, receiving a configuration, or preconfiguration, for a serving cell. The configuration (preconfiguration) may include a duplexing SBFD configuration for each time resource (slot and symbol), including the frequency position and size of the UL and DL sub-bands, one or more CLI measurements and reporting configuration (e.g., L1-CLI-RSSI or L1-SRS-RSRP), the corresponding resources (RBs in the UL or DL sub-bands), an indication enabling dynamic guard-band configuration based on CLI measurements, based on WTRU capability, including e.g. a trigger on CLI measurement associated with a CLI threshold, a dynamic guard-band granularity (e.g., as a number of RBs), and an indication of the method to perform partial transmissions overlapping the guard-band. Methods include e.g., puncturing or rate-matching or skipping, where puncturing may be the default option.

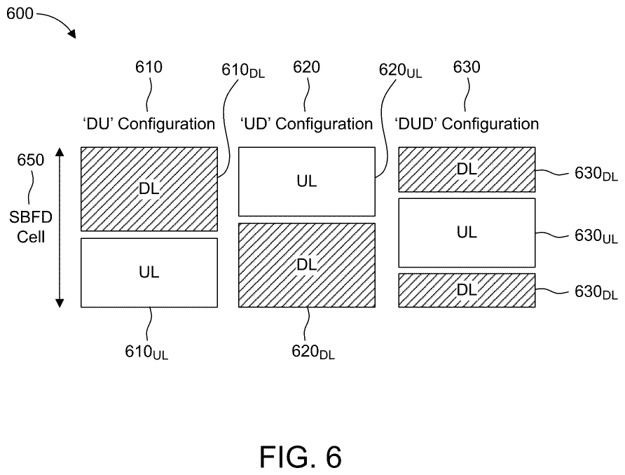

FIG. 6 illustrates multiple configurations 600 that may occur in SBFD configurations. For example, the configurations 600 may be received in step 510 described above. In a DU configuration 610, the SBFD cell 650 includes the DU configuration DL 610_{DL} and UL 610_{UL}. In a UD configuration 620, the SBFD cell 650 includes the UD configuration UL 620_{UL} and DL 620_{DL}. In a DUD configuration 630, the SBFD cell 650 includes the DUD configuration DL 630_{DL}, UL 630_{UL}, and DL 630_{DL}.

Method 500 may include, at 520, receiving a resource allocation for transmissions, e.g., an UL periodic/configured grant, e.g., via RRC reconfiguration, MAC CE activation or DCI UL grant. This receiving at 520 may include receiving the time/frequency resources over which the transmission is to occur. Information such as the periodicity, repetition, etc., if any, may be received. Further details on the receiving are described herein below.

Method 500 may include, at 530, performing the configured CLI measurement and detecting that some RBs of the configured resources are beyond the configured CLI threshold to trigger the determination of the dynamic guard-band (e.g., punctured RBs). For example, the RBs may correspond to the frequency edge of the sub-band (e.g., being limited within the subband).

Method 500 may include, at 540, determining a set of RBs (e.g., RBs in the UL sub-band) to use as the dynamic guard-band (e.g., punctured RBs) based on the CLI measurement. For example, the dynamic guard-band size and position correspond to the RBs beyond the threshold, and may be based on the configured RB granularity.

Method 500 may include, at 550, performing a (partial) UL transmission based on the resource allocation by puncturing the determined set of RBs (as the dynamic guard band). This performing at 550 may include reporting information on the applied punctured RBs (e.g., dynamic guard-band position and size) and/or the CLI measurements based on the CLI measurements and reporting configuration. As described the UL transmission and the reporting of the guard band may be performed jointly. As would be understood, the UL transmission and the reporting of the guard band may occur as two separate steps, i.e., in separate transmissions, for example. Similarly, to the extent the description includes separate transmission of the UL transmission and the reporting of the guard band, those two steps may be performed jointly.

Method 500 may include, at 560, receiving an indication from the network acknowledging the reported dynamic guard-band (position on the punctured RBs), e.g., via MAC/DCI, and updating the current SBFD subband configurations including guard-band(s). The indication may further include a change of partial transmission method (e.g., puncturing or rate-matching). On condition that the default option is changed to the rate-matching (instead of puncturing), the WTRU may perform a UL transmission by applying rate-matching based on the current SBFD guard-band(s), where applying the additional dynamic guard-band is disabled (deactivated) until a re-activation command is received.

Method 500 may provide dynamic adaptation based on WTRU-specific CLI conditions (e.g., not semi-static configuration applied to the whole cell) and not just based on WTRU capability to achieve improved signal quality in the network.

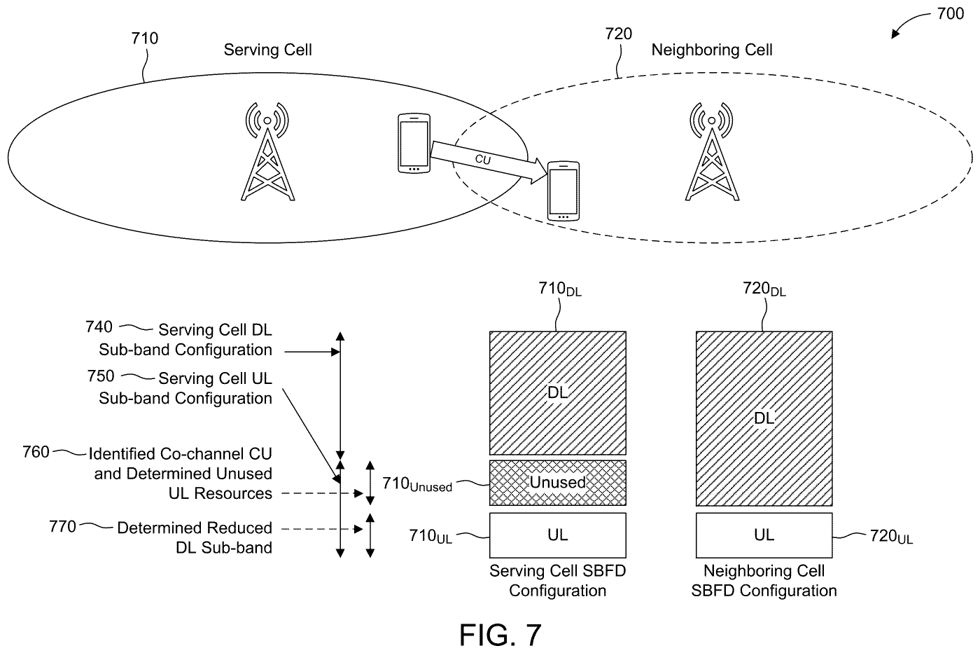

FIG. 7 illustrates an exemplary WTRU-based configuration 700 where the WTRU does not use overlapping resources in its UL subband. Configuration 700 includes a serving cell 710 and a neighboring cell 720. Serving cell 710 includes a DL 710_{DL}, an UL 710_{UL}, and an unused portion 710_{UNUSED}. Neighboring cell 720 includes a DL 720_{DL} and an UL 720_{UL}. As described above, there is a serving cell DL sub-band configuration 740 and a serving cell UL sub-band configuration 750. As illustrated in configuration 700, serving cell DL sub-band configuration 740 corresponds to DL 710_{DL} and serving cell UL sub-band configuration 750 is divided into an identified co-channel CLI and determined unused UL resources 760 corresponding to the unused portion 710_{UNUSED} and a determined reduced UL sub-band 770 corresponding to UL 710_{UL}.

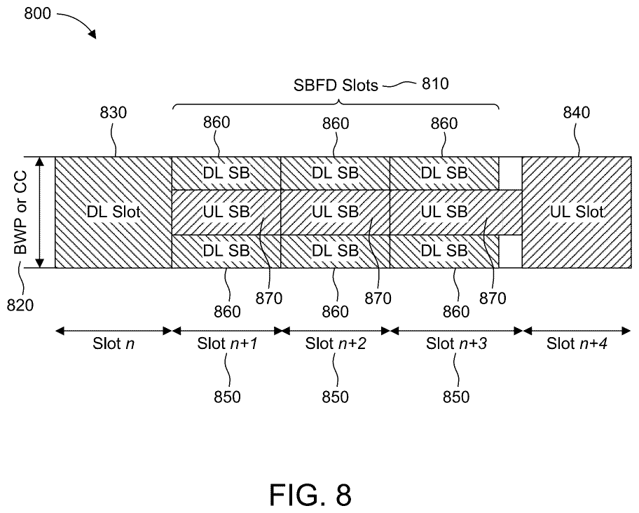

FIG. 8 illustrates an exemplary SBFD configuration 800. In configuration 800, a WTRU may be configured with one or more types of slots 810 within a bandwidth 820. A first type of slot 830 may be used or determined for a first direction (e.g., downlink, or sidelink (e.g., WTRU-to-WTRU communication, device-to-device communication)); a second type of slot 840 may be used or determined for a second direction (e.g., uplink, or sidelink); a third type of slot 850 may have a first group of frequency resources within the bandwidth for a first direction and a second group of frequency resources within the bandwidth for a second direction. Herein, the bandwidth 820 may be interchangeably used with bandwidth part (BWP) 820, carrier, sub-band, and system bandwidth. First type of slot 830 (e.g., the slot for a first direction) may be referred to as downlink (and/or sidelink) slot. Second type of slot 840 (e.g., slot for a second direction) may be referred to as uplink (and/or sidelink) slot. Third type of slot 850 may be referred to as Sub-Band (non-overlapping or overlapping) Full Duplex (SBFD) slot 810, e.g., comprising at least one of DL SB(s) 860, UL SB(s) 870, sidelink SB(s), guard band(s) (not shown in the figure as the guard-band is in-between an UL sub-band and DL sub-band) (or RB(s)), and flexible SB(s) (e.g., SB(s) that may be dynamically determined as one of DL SB(s) 860, UL SB(s) 870, sidelink SB(s)). The group of frequency resource for a first direction may be referred to as downlink (and/or sidelink) sub-band, downlink (and/or sidelink) frequency resource, or downlink (and/or sidelink) RBs. The group of frequency resource for a second direction may be referred to as uplink (and/or sidelink) sub-band, uplink (and/or sidelink) frequency resource, or uplink (and/or sidelink) RBs. The group of frequency resource for a flexible direction (e.g., that can be configured for a first direction, second direction, etc.) may be referred to as flexible sub-band, flexible frequency resource, or flexible RBs. The group of frequency resource between a first direction and a second direction may be referred to as guard band, guard frequency resource, or guard RBs.

In one example, a WTRU may be (pre) configured with one or multiple groups of frequency resources, where some groups of frequency resources are explicitly configured, and some are implicitly configured. For instance, the WTRU may be configured, e.g., within a cell or BWP, with a first group of frequency resources assigned to DL and a second group of resources assigned to UL. The WTRU may determine that the remaining group(s) of resources are used as guard band. Alternatively, the WTRU may receive a configuration including an UL sub-band and a guard band, and determine that the remaining resources are a DL sub-band, and so forth.

In an example, a (SBFD-enabled) WTRU may receive configuration information or be configured with one or more SBFD UL, DL, sidelink, flexible, and/or guard sub-bands in one or more DL/UL/flexible TDD time instances (e.g., symbols, slots, frames, and so forth). The WTRU may be configured with one or more resource allocations for SBFD sub-bands.

For example, the SBFD configuration may include a flag signal (e.g., enabled/disabled), where for example a first value (e.g., zero (0) indicates a first mode of operation (e.g., SBFD configuration), and a second value (e.g., one (1) may indicate a second mode of operation (e.g., non-SBFD operation). The modes of operation (e.g., SBFD and/or non-SBFD) may be indicated via MIB, SIB, RRC, MAC-CE, DCI, and so forth.

The WTRU may receive the time resources (e.g., one or more symbols, slots, and so forth), for which the first mode of operation (e.g., SBFD) is defined in for example one or more BWPs, sub-bands, component carriers (CC), cells, and so forth. The WTRU may receive the frequency resources (e.g., sub-bands/BWPs including one or more PRBs) within (active and/or linked) BWP, for which the first mode of operation (e.g., SBFD) is configured. The time instances (e.g., slots, symbols) may be indicated based on periodic, semi-persistent, or aperiodic type configurations. In an example, the time instances may be indicated via a bitmap configuration, where each bit corresponds to a time instance (e.g., slot, symbol, subframe, etc.) and each bit indication indicates whether corresponding time instance can be used for the first or second mode of operation.

In an example, a WTRU may be configured with a DL TDD configuration for a component carrier (CC) or a BWP for one or more Rx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., sub-bands, PRBs, and/or BWPs) may be configured for the transmission in UL channels and/or Tx occasions.

In an example, the WTRU may be configured with an UL TDD configuration for a component carrier (CC) or a BWP for one or more Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., sub-bands, PRBs, and/or BWPs) may be configured as the DL channels and/or Rx occasions.

In an example, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., sub-bands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where for example a first value (e.g., zero (0)) may indicate a first direction (e.g., UL duplexing mode), and a second the value (e.g., one (1) may indicate a second direction (e.g., DL duplexing model).

The duplexing mode configuration and/or flag for the first mode of operation (e.g., SBFD) may be configured as part of modes of operation configuration, for example via MIB, SIB, RRC, DCI, MAC-CE, etc.

The duplexing mode configuration and/or flag for the first mode of operation (e.g., SBFD) may be configured as part of resource allocation configuration for a Tx/Rx occasion.

In an example, a WTRU may be configured with one or more types of slots. The WTRU may be configured with a first slot with a first type, where the first type may be for example SBFD slot. The WTRU may be configured with a second slot with a second type, where the second type may be for example non-SBFD slot. As for the first slot with the first type (SBFD), the WTRU may be configured with one or more DL, UL, flexible, guard, etc. sub-bands in the frequency domain, throughout the BWP, for the duration of the first slot. However, in the second slot with the second type (non-SBFD), the WTRU may be configured with only one direction type, for example DL, UL, flexible, etc., in the frequency domain, throughout the BWP, for the duration of the second slot.

In an example, if the WTRU is configured with a second slot with UL direction, this implies legacy TDD UL slot, UL-only slot, and/or non-SBFD UL slot. In an example, if the WTRU is configured with a third slot with second type (non-SBFD) with DL direction, this implies legacy TDD DL slot, DL-only slot, and/or non-SBFD DL slot. In another example, if the WTRU is configured with a fourth slot with second type (non-SBFD) with flexible direction, this implies legacy TDD flexible slot and/or non-SBFD flexible slot, and so forth.

In an example, the WTRU may be configured with a SBFD ‘DU’ configuration, referring to a configuration where the upper-frequency sub-band of the cell's carrier is configured as a Downlink sub-band, while the lower-frequency sub-band of the same cell's carrier is configured as an Uplink sub-band. One or more guard-band (i.e., unused frequency resources) may be configured at the edge of the cell's carrier or in between sub-bands.

In an example, the WTRU may be configured with a SBFD ‘UD’ configuration, referring to a configuration where the upper-frequency sub-band of the cell's carrier is configured as an Uplink sub-band, while the lower-frequency sub-band of the same cell's carrier is configured as a Downlink sub-band. One or more guard-band (i.e., unused frequency resources) may be configured at the edge of the cell's carrier or in between sub-bands.

In an example, the WTRU may be configured with a SBFD ‘DUD’ configuration, referring to a configuration with three sub-bands and both the upper-frequency and lower-frequency sub-band of the cell's carrier is configured as Downlink sub-bands, while the middle-frequency sub-band of the same cell's carrier is configured as an Uplink sub-band. One or more guard-band (i.e., unused frequency resources) may be configured at the edge of the cell's carrier or in between sub-bands.

In an example, the WTRU may be configured with a SBFD ‘UDU’ configuration, referring to a configuration with three sub-bands and both the upper-frequency and lower-frequency sub-band of the cell's carrier is configured Uplink sub-bands, while the middle-frequency sub-band of the same cell's carrier is configured as a Downlink sub-band. One or more guard-band (i.e., unused frequency resources) may be configured at the edge of the cell's carrier or in between sub-bands.

A WTRU may receive configurations of (e.g., may be configured with) SBFD sub-band time locations that may be configured within a period. In an example, the period may be the same as TDD-UL-DL pattern period configured by dl-UL-TransmissionPeriodicity, e.g., in TDD-UL-DL-ConfigCommon. In an (e.g., another) example, the period may be an integer multiple of TDD-UL-DL pattern period configured by dl-UL-TransmissionPeriodicity, e.g., in TDD-UL-DL-ConfigCommon.

When a TDD-UL-DL pattern is configured, SBFD symbols may be configured in consecutive manner within a TDD-UL-DL pattern period. When two TDD-UL-DL patterns are configured and if SBFD symbols are configured for only one of the patterns, SBFD symbols may be configured in consecutive manner within the TDD-UL-DL pattern period. When two TDD-UL-DL patterns are configured and if SBFD symbols are configured for both patterns, SBFD symbols may be configured in consecutive manner within each TDD-UL-DL pattern period.

A WTRU may be configured with one or more SBFD configurations, changing over time. The WTRU may receive multiple configurations for different SBFD patterns, such as one or more DU, UD, DUD or UDU patterns. The WTRU may receive the configuration to apply a time pattern where different of these SBFD configurations are used over time. In an example, the period may be the same as TDD-UL-DL pattern period configured by dl-UL-TransmissionPeriodicity, e.g., in TDD-UL-DL-ConfigCommon. In an example, the period may be an integer multiple of TDD-UL-DL pattern period configured by dl-UL-TransmissionPeriodicity, e.g., in TDD-UL-DL-ConfigCommon.

A WTRU may be configured with dedicated SBFD configuration, where the WTRU receives, e.g., via RRC dedicated signaling, the SBFD configuration to apply on selected time resources. This may apply the same pattern and periods as the RRC (re)configuration TDD-UL-DL-ConfigDedicated field.

A WTRU may be configured with multiple (serving) cells, e.g., for Carrier Aggregation (CA), and in the case of Dynamic SBFD configuration, the WTRU may be configured with different SBFD configuration at the same time across different cells.

In the network, geographically neighboring cells (that may be controlled by different gNBs or nodes) may be configured with independent SBFD configuration, e.g., using different SBFD patterns and/or different sub-band size and position configuration. The network may be able to exchange information about the configuration of the different cells between gNBs.

A WTRU may determine (or be indicated/configured with) that ‘UL usable PRBs’ are a part of UL sub-band frequency resources within an UL BWP (e.g., an active UL BWP, a currently active UL BWP), and ‘DL usable PRBs’ are a part of DL sub-band frequency resources within an DL BWP (e.g., an active DL BWP, a currently active DL BWP). The UL usable PRBs may be determined as an intersection between a configured or indicated UL sub-band and an active UL BWP in SBFD symbols (and/or slots). The DL usable PRBs may be determined as an intersection between a configured or indicated DL sub-band(s) and an active DL BWP in SBFD symbols (and/or slots). In an (e.g., another) example, the UL and/or DL usable PRBs may be explicitly configured within active UL and/or DL BWP, e.g., in SBFD symbols and/or slots.

In an example, a WTRU may receive information on frequency resource allocation (e.g., Type 0 as RBG-level bitmap-based resource assignment) for a PDSCH or PUSCH (as being scheduled) in a slot(s). When an assigned RBG overlaps with a sub-band boundary, the WTRU may determine that (only) the PRBs within DL usable PRBs are to be valid for PDSCH reception and (only) the PRBs within UL usable PRBs are to be valid for PUSCH transmission, e.g., where this may imply “partial RBG” is allowed and valid for resource allocation.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following: CSI report configuration, CSI-RS resource set, and NZP CSI-RS resources. The CSI Report Configuration, including one or more of the following: CSI report quantity, e.g., Channel Quality Indicator (CQI), Rank Indicator (RI), Precoding Matrix Indicator (PMI), CSI-RS Resource Indicator (CRI), Layer Indicator (LI), etc., CSI report type, e.g., aperiodic, semi persistent, periodic, CSI report codebook configuration, e.g., Type I, Type II, Type II port selection, etc., and CSI report frequency. The CSI-RS Resource Set, including one or more of the following CSI Resource settings: NZP-CSI-RS Resource for channel measurement, NZP-CSI-RS Resource for interference measurement, and CSI-IM Resource for interference measurement. The NZP CSI-RS Resources, including one or more of the following: NZP CSI-RS Resource ID, Periodicity and offset, QCL Info and TCI-state and Resource mapping, e.g., number of ports, density, CDM type, etc.

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth). In the case where L1-CLI-RSSI is used, the WTRU does not perform L3 filtering over multiple measurement samples, which may help identify time bursts of interferences.

Sounding reference signals RSRP (SRS-RSRP) may be measured based on the linear average over the power contribution of the resource elements (RE) that carry the respective SRS. In the case where L1-SRS-RSRP is used, the WTRU does not perform L3 filtering over multiple measurement samples, which may help identify time bursts of interferences.

“The WTRU is configured”, “the WTRU is preconfigured”, “the WTRU received a configuration”, “the WTRU received a pre-configuration”, may be interchangeably used. These may be used to identify that the WTRU received an indication from the network, either from RRC (re)configuration, MAC indication, DCI signaling or MIB/SIB indication, which can be explicit or implicit, based on the specification, or that the WTRU has an internal setting or default setting of the configuration without additional network signaling.

The “dynamic guard-band” refers to the frequency domain resources for which the WTRU will avoid transmitting (or receiving) to avoid co-channel CLI. The dynamic guard-band may be restricted to certain time resources (slots/symbols).

A “muting” a resource is equivalent and may interchangeably be used together with: “not transmitted” or “not receiving”. Resources that are identified to be outside of the usable resources (i.e., in a (dynamic) guard-band, or in a sub-band of the opposite direction, or outside an active BWP), are typically considered muted unless explicit exceptions are mentioned.

A WTRU may receive configurations (e.g., from a gNB, a node, or a device) for full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time the WTRU either performs a UL transmission or a DL reception (not both simultaneously at the given time). The WTRU may (also) operate in an FD mode for communicating with the gNB, e.g., if a corresponding WTRU capability signal(s) is reported to the gNB and/or the WTRU receives a confirmation signal (e.g., enabling the FD, configuring the FD mode) in response to transmitting the WTRU capability signal(s).

The FD operation may imply at a given time a transmitter (e.g., the gNB and/or the WTRU) may simultaneously transmit a first signal and receive a second signal. The FD operation may comprise a sub-band overlapping FD (e.g., in-band FD (IBFD)) operation where a first frequency-domain resource (e.g., RBG(s), RB(s), RE(s) allocated for the first signal may have a full (or at least a partial) overlap with a second frequency-domain resource allocated for the second signal. The FD operation may comprise a sub-band non-overlapping FD (SBFD) operation where a first frequency-domain resource allocated for the first signal (e.g., assigned within a configured SBFD sub-band, e.g., DL sub-band, usable DL PRBs) does not have an overlap with a second frequency-domain resource allocated for the second signal (e.g., assigned within a configured SBFD sub-band, e.g., UL sub-band, usable UL PRBs).

The FD operation may include the SBFD operation, however the described configurations and methods may equally (or equivalently or extendedly, etc.) be employed for cases with other FD operation types (e.g., IBFD, etc.).

A WTRU may receive SBFD-related configuration(s), e.g., for frequency-domain location information of one or more sub-bands (e.g., DL sub-band, UL sub-band, flexible DL/UL sub-band, and/or guard-band), and/or for time-domain location information of the one or more sub-bands. The time-domain location information may indicate a set of non-SBFD symbols and a set of SBFD symbols (e.g., as illustrated in FIG. 8). A symbol(s) within the set of non-SBFD symbols may be a type of ‘DL symbol’, ‘UL symbol’ or ‘flexible symbol’. The WTRU may receive a DL signal on symbol(s) based on a type of ‘DL symbol’ in the set of non-SBFD symbols. The WTRU may transmit a UL signal on symbol(s) based on a type of ‘UL symbol’ in the set of non-SBFD symbols. The WTRU may either receive a DL signal or transmit a UL signal on symbol(s) based on a type of ‘flexible symbol’ in the set of non-SBFD symbols, e.g., depending on one or more conditions with other signal(s) co-existing in the symbol(s).

A WTRU may receive an indication of a (re)configuration of the duplexing directions/patterns for its configured cell(s). For example, the WTRU may receive a SIB (SIB1) message on a cell or RRC (re)configuration indicating a duplexing (re)configuration for the different time resources of a cell, for instance, via the tdd-UL-DL-Configuration common parameter (re)configuration, e.g., which slots and/or symbols are in the Uplink direction and which are in the Downlink direction. The time resource may also be configured as Flexible, where the time resource is dynamically or semi-statically configured by the network and/or given through dedicated WTRU configuration. For example, the WTRU may receive an indication about common SBFD configuration of a cell, e.g., through SIB (e.g. SIB1) or through RRC (re)configuration. The WTRU may then be configured with slots and symbols that are either ‘DU’, ‘UD’, ‘DUD’, ‘UDU’, or regular downlink or uplink configuration. For example, the WTRU may receive a dedicated configuration indicating an update of the duplexing direction of a cell for selected time resources (slots/symbols), e.g., via the RRC (re)configuration TDD-UL-DL-ConfigDedicated field. For example, the WTRU may receive an indication about dedicated SBFD configuration of a cell for selected time resources (slots/symbols), through RRC, MAC or DCI (re)configuration. The WTRU may then be configured with slots and symbols that are either ‘DU’, ‘UD’, ‘DUD’, ‘UDU’, or regular downlink or uplink configuration.

A WTRU may receive (re)configurations for Dynamic SBFD configuration, where different time resources are configured to apply different SBFD configurations. For example, one slot or symbol may be configured with a first SBFD pattern (e.g., ‘DU’) and another slot or symbol may be configured with a second SBFD pattern (e.g., ‘UD’), within the configuration period. In another example, the WTRU may be configured so that one slot or symbol is applying a first configuration of ‘DU’ pattern (e.g., with a first split of the frequency resources between the Downlink, Uplink and guard band if any), and another slot/symbol is configured with a second configuration of the ‘DU’ pattern (e.g., with a second split of the frequency resources between the Downlink, Uplink and guard band if any).

A WTRU may receive configurations for Bandwidth Adaption in which the WTRU is configured with multiple Bandwidth Parts (BWPs). A BWP consists in a subset of the total bandwidth of a cell, e.g., as a number and starting position of PRBs. A WTRU may have multiple BWPs configured for UL or DL. A WTRU may be configured with active BWP(s) and the (de)activation of BWPs may be following a (pre)configured time pattern or be dynamically (e.g., using DCI or MAC CE indication) signaled.

A WTRU may receive a (pre)configuration to perform measurement and reporting of the CLI. The WTRU may receive the indication to perform CLI-RSSI measurements, to evaluate the overall received power on a selection of resources (e.g., REs/RBs) over one or multiple symbols indicated in the received configuration. The WTRU may receive the indication to perform SRS-RSRP measurements, to evaluate the power contribution of a specific WTRU, on a selection of resources (e.g., REs/RBs) over one or multiple symbols indicated in the received configuration (including the SRS configuration such as comb, resources, IDs). The WTRU may receive the indication to perform non-CLI measurements, but a measurement to be used as a proxy for CLI. Hereafter, any CLI-measurement may also equivalently refer to a non-CLI measurement used as a proxy for CLI using one of the following. For example, the WTRU may be configured to measure CSI for Interference Management (CSI-IM) with the corresponding CSI-IM resources that measure the interference from neighboring cells. The WTRU may also be configured to measure CSI-RS configured as Zero-Power (ZP-CSI-RS), to be able to measure the noise/interference from neighboring cells. The WTRU may also be configured to measure the neighboring cell using e.g., SSB measurements.

The WTRU may be configured to perform L1-based measurements (e.g. L1-CLI-RSSI, L1-SRS-RSRP, L1-CSI-IM, L1-CSI-RS, . . . ) or higher layer-based measurements (e.g., CLI-RSSI, SRS-RSRP, L1-CSI-IM, L1-CSI-RS, . . . ), where the L1-based measurement is not averaged over multiple time resources, to evaluate instantaneous interference. The WTRU may be configured with the measurement resources on different parts of the SBFD sub-bands: In one example, the resources to perform the measurement are located on a DL sub-band of the configured SBFD pattern, at least for some time resources. In one example, the resources to perform the measurement are located on a UL sub-band of the configured SBFD pattern, at least for some time resources. In one example, the resources to perform the measurement are located on a guard-band of the configured SBFD pattern (if any), at least for some time resources.

The WTRU may receive the indication to perform a CLI measurement using a specific receiver beam (e.g., spatial transformation), using the receiver beam corresponding to a known DL transmission (e.g., using a TCI/QCL reference). For example, the WTRU may be indicated to perform measurement using a RX beam similar to the RX beam used for a given RS (e.g., a PSCCH or PSSCH DMRS, SSB, PTRS, etc.); or it could be configured to use the same beam as it uses to perform an UL transmission, e.g., the same beam as for a PUSCH/PUCCH/RACH transmission. The indication may be given together with the CLI measurement configuration, e.g., via RRC, MAC, DCI configuration, and may also be (re)configured afterwards, for a given or all CLI measurements configurations, e.g., by RRC, MAC or DCI indications.

The WTRU may receive the indication (implicit or explicit) to perform a CLI measurement using a wideband measurement and reporting, i.e., where the measured quantity is average over all the configured measurement resources in the frequency domain. The WTRU reports the quantity for the entire CLI measurement resources. The WTRU may receive the indication that the CLI measurement is configured as a periodic, semi-persistent or aperiodic measurement. The WTRU may receive this configuration via RRC (re)configuration or pre-configuration. Periodic measurements are active until the WTRU receives a further (re)configuration of the measurement. The WTRU may be indicated to start/stop (activate/deactivate) a semi-persistent measurement, e.g., using RRC/MAC or DCI indication. Periodic and semi-persistent measurements configuration include the time resources on which to perform the measurements, e.g., the time period between two measurements, e.g. expressed in ms. Aperiodic measurement configurations may include a time/frequency resource indication and the WTRU further receive indications from the network, e.g., via MAC or DCI indication, to perform the aperiodic measurement.

The WTRU may receive the indication that the CLI measurement is configured with a periodic, semi-persistent or aperiodic reporting. The WTRU may receive this configuration via RRC (re)configuration or pre-configuration. Periodic reporting are active until the WTRU receives a further (re)configuration of the measurement. The WTRU may be indicated to start/stop (activate/deactivate) a semi-persistent reporting, e.g., using RRC/MAC or DCI indication. Periodic and semi-persistent reporting configuration include the resources indications (e.g., on PUCCH or PUSCH) on which to transmit the reports and, the time period between two reports, e.g. expressed in ms. Aperiodic report configurations may include a resource indication (e.g., on PUCCH or PUSCH), implicitly or explicitly on which to transmit the reports and the WTRU further receive indications from the network, e.g., via MAC or DCI indication, to perform the aperiodic measurement/reporting. The WTRU may also be configured with autonomous reporting, where the WTRU determines to report the CLI based on triggers such as:

The WTRU may receive a configured threshold associated with a CLI measurement and the WTRU measured a CLI that is beyond that threshold. The WTRU may then report the corresponding CLI measurement, including measurement ID (or the corresponding resources) and measurement quantities/values. The WTRU may be (pre)configured with a timer, e.g., that is (re)started when the WTRU received the configuration and/or the WTRU reported the measurement; and the WTRU may be configured to transmit the report when the timer expires. The WTRU may receive the indication (implicit or explicit) to perform a CLI measurement using a subband measurement and reporting, i.e., where the perform separated measurements and generates multiple reporting quantity for different parts of the frequency domain of the configured measurement resource. The WTRU may receive the indication of the reporting subband size (e.g. a number of RBs per reporting subband, e.g., 4, 8, 16, that may be dependent on the carrier/BWP/subband size). The WTRU may report the measured quantity for one or multiple reporting sub-bands, including the quantity and its associated subband, e.g., referred to with a subband index. The subband reporting may be beneficial to use to evaluate the frequency selectivity of the interference.

The WTRU may receive a configuration of a CLI measurement and report associated with a threshold (e.g., based on CLI-RSSI, SRS-RSRP, L1-CLI-RSSI or L1-SRS-RSRP). The WTRU may use the threshold as a condition to trigger, e.g., WTRU reporting of the measurement. The WTRU may be configured with one or more thresholds for a given measurement. A first threshold may be applicable for L1-SRS-RSRP measurements while a second threshold is applicable for L1-CLI-RSSI measurements. In an example, a first threshold may apply for a measurement over more than a first number of RBs and a second threshold may apply for a measurement over more than a second number of RBs. In an example, a first threshold may apply for a wideband measurement and reporting configurations, and a second threshold may apply for a subband-based measurement and reporting.

The WTRU may be a WTRU capable of performing specific CLI measurement, CLI avoidance and related features. The WTRU may report to the network its capabilities, e.g., using RRC and/or MAC indications. The WTRU may be capable of performing CLI measurements with a lower frequency-domain granularity than the configured CLI measurement and report. For example, the WTRU, configured with a CLI measurement and reporting, may also be capable of measuring, reporting or triggering actions based on a subset of the configured CLI measurements resources (wideband or subband-based reporting). The WTRU may include in its capability the granularity it is capable of supporting, e.g., 1 RB, 2 RBs, 4 RBs, 8 RBs, etc. For example, the WTRU may be capable of identifying the specific RBs (position and numbers) within the resources of CLI measurement, where the RBs are measured beyond a threshold while other are measured below a threshold. The WTRU may be capable of performing CLI avoidance procedures/schemes, e.g., by introducing a dynamic guard band or by adapting the transmissions/receptions of signals based on CLI measurements. Schemes may include: puncturing transmissions, applying rate-matching to reduced transmission resources, skipping transmissions.

The WTRU may receive from the network and indication enabling and/or configuring CLI measurement-based actions to avoid/reducing CLI in the network, e.g., based on the reported WTRU capabilities. The indication may be received using RRC, MAC or DCI signaling and may include an association between a CLI measurement and a SBFD subband. The WTRU receives a configuration where a CLI measurement, the corresponding CLI measurement resources and a sub-band are associated. The subband may be either a UL or a DL subband. In an example, the association may be between all the resources of the CLI measurement and the SBFD sub-band. In an example, the association may be between a part of the resources of the CLI measurement and the SBFD sub-band. For example, the association may be with one or more CLI reporting sub-bands of the CLI measurement resources. For example, the association may be with an indicated set of RBs of the CLI measurement resources. For example, the association may be with an indicated set of RBs of the SBFD subband. The indicated resources may correspond to an overlap of a UL and DL subband between a serving cell and a neighboring cell, based on network's knowledge.

In an example, the association may be between parts of the CLI resources and the SBFD subband that correspond to an overlap between sub-bands of opposite directions between the serving cell and a neighboring cell. The WTRU may receive the SBFD configuration of its serving cell, and the SBFD configuration of a neighboring cell on the same frequency carrier (co-channel). The SBFD configuration indicating the subband configurations (frequency and directions) and the associated time resources. The WTRU may determine that for some time resources, the serving and neighboring cell have opposite direction subband overlapping in the frequency domain. For example, the serving cell has an UL subband overlapping with a DL subband of the neighboring cell. The WTRU may associate a part of the CLI resources and/or of the subband corresponding to the RBs in the overlap. For example, the WTRU may receive the SBFD configuration of its serving cell, and the SBFD configuration of a neighboring cell on the same frequency carrier (co-channel), e.g., via RRC/MAC/DCI indication. In an example, the WTRU may receive the SBFD configuration of the neighboring cell from monitoring the signaling from the neighboring cell, e.g., by reading MIB/SIB information. In an example, the WTRU may receive the SBFD configuration of the neighboring cell from another WTRU, e.g., using Sidelink transmissions (e.g., via SL-RRC, SL-MAC or SCI information) the SBFD information of the neighboring cell, for the cell common configuration and/or WTRU specific configuration.

A threshold based on the configured CLI measurement, for which the WTRU may trigger the CLI-measurement based dynamic guard-band. The WTRU may receive a threshold applicable for wideband measurement, i.e., all the configured frequency resource. The WTRU may receive a threshold applicable for set of RBs (with the corresponding set of resources or the size of sets of RBs) or reporting subband measurements, i.e., for frequency-selective measurements of the configured resources. The WTRU may receive a first threshold for selected sets of RBs/sub-bands, and a second threshold for the rest of the configured measurement resources. For instance, the first threshold may apply on an overlap of UL and DL sub-bands between a serving and neighboring cell. In another example, a first threshold can be used for frequency resources adjacent to a subband edge and the second threshold for other resources. The WTRU may receive a first threshold to trigger CLI measurement reporting; and a second threshold may be used to trigger CLI-measurement based dynamic guard-band. The WTRU may receive multiple thresholds, and each may be associated with different CLI-measurement based dynamic guard-band methods.

Certain methods may be used for transmissions with the dynamic guard-band when the WTRU measures CLI above a configured threshold on some (time/frequency) resources. Methods includes, for example: puncturing, rate-matching, transmissions cancellation. The WTRU may further be configured with conditions for which to apply a first method and other conditions for which to apply another method. The WTRU may be configured to puncture a scheduled/granted UL transmission, i.e., the WTRU prepares the transmission normally but does not transmit on the punctured resources. The transmission is therefore “incomplete”, but the network may still decode the transmission if a limited part of it is missing (e.g., due to channel coding, redundancy etc.) or if the transmission is split into independent segments. With rate-matching, the WTRU may consider the missing resources in the determination of the transport block (TBS, MCS, etc.) and prepare the transmission parameters using the remaining resources. This increases the rate of the transmission and may be more likely to generate decoding issues. The WTRU may cancel the transmission of the data if some of the configured/granted resources are overlapping with the CLI-identified resources. The WTRU may be (pre)configured with a default method. For example, the puncturing method may be used as a default method. The WTRU may be configured to use a first method when the CLI resources have been identified but not reported yet, and another method when the WTRU reported the resources with CLI. The WTRU may be configured with conditions for the selection of which method to apply, e.g., based on one or more of: The WTRU may have reported some capabilities about the supported CLI avoidance methods and may only consider the methods that have been reported. The WTRU may be configured with multiple CLI thresholds. For instance, if the CLI is above a first threshold (and below a second threshold), the WTRU may use a first method; and if the CLI is above a second threshold, the WTRU may use a second method. The WTRU may select the method to apply based on the number of RBs identified with CLI (the dynamic guard band). For example, if the number (in number of RBs or as a ratio of the carrier/subband/BWP) is higher than a threshold, the WTRU may select a first method while if it is lower, use another method. The WTRU may select the method to apply based on the signal quality with the serving cell, e.g., based on SSB or CSI-RS measurements. If the signal quality is higher than a threshold, the WTRU may select a method, while if it is lower, the WTRU select another method. The WTRU may also evaluate the likelihood of decoding success, e.g., based on serving cell quality (e.g., based on DL measurements), the data quantity to transmit, the transport format (TBS, MCS, etc.) and/or the ratio of resources actually transmitted vs resources scheduled/granted (i.e., removing the muted resources in the dynamic guard-band). For instance, if a first method becomes impossible, e.g., if the WTRU punctures too many resources that the network will not be able to decode; or if the MCS becomes too high for the signal quality; the WTRU may select to cancel the transmission.

Certain conditions may be applied (or not performed) for the CLI-based dynamic guard-band on identified resources. The WTRU may be (pre)configured with exceptions for which the WTRU will perform the transmission even if the CLI has been identified. Exceptions can be (pre)configured based on, for example: Transmissions whose priority is below a threshold may not be affected by the dynamic guard-band. Transmission whose QoS requirement are strong, e.g., latency or remaining delay budget is below a threshold may not be affected by the dynamic guard-band. The WTRU may apply the dynamic guard-band on some TX beam and not apply on some others. For example, the WTRU may apply the dynamic guard-band only on the beams for which the CLI was measured/identified. In an example, the WTRU may receive a (set of) beam(s) for which it may not be affected by the dynamic guard-band. The WTRU may be (pre)configured to apply the dynamic guard-band to selected types of channels, e.g., only for PUSCH and PUCCH, but not RACH; or only for PUSCH but not PUCCH or RACH. The WTRU may be (pre)configured to apply the dynamic guard-band on periodic transmissions only, not on aperiodic transmissions. The WTRU may be (pre)configured to not apply the dynamic guard-band on retransmissions, e.g., if the initial transmission was transmitted normally. The WTRU may be (pre)configured to not apply the dynamic guard-band if the transmission is a UCI, includes a UCI, includes an ACK/NACK, includes CSI/CLI report, or includes a MAC or RRC signaling, etc. For instance, a WTRU in the cell center or not in the cell edge may be exempted of performing the dynamic guard-band. Conditions such as CSI/channel quality from the serving cell, e.g., if the WTRU measures the serving cell, e.g., CSI-RS or SSB-based RSRP/RSRQ, RSSI, or SINR is higher than a threshold, the WTRU may be (pre)configured to not apply the dynamic guard-band, transmission parameters, such as MCS, code-rate, number of layers, etc., if the WTRU is configured with such transmission parameter above a threshold, the WTRU may be (pre)configured to not apply the dynamic guard-band, location, if the WTRU, using its location (e.g., absolute/relative to the cell), determines that it is at a distance lower than a threshold, the WTRU may be (pre)configured to not apply the dynamic guard-band, and light-of-Sight (LOS), if the WTRU is in LOS with the serving cell, the WTRU may be (pre)configured to not apply the dynamic guard-band. The examples of condition may be reversed with respect to a neighboring cell (e.g., with the same or another threshold and opposite condition).

The WTRU may perform the configured CLI measurement (e.g., to measure a quantity L1-CLI-RSSI, L1-SRS-RSRP or L1-CSI-IM, . . . ) on the corresponding configured resources, which may be a periodic measurement or by receiving an activation/trigger from a MAC/DCI indication.

The configured measurement resources may span over a number or REs or RBs, and the WTRU may, depending on the received configuration, perform the measurement over all the configured resources in the frequency domain (wideband) or perform subband-based measurements, where the resources are split in chunks of fewer RBs (e.g., 4, 8, 16, . . . ) to create measurement and reporting sub-bands.

The WTRU may detect that the measured CLI values are, at least on some parts of the configured resources, beyond the corresponding threshold based on the received configuration. The WTRU may detect that the measured value is above a threshold for the averaging over all the configured frequency-domain resources of the measurement (wideband). The WTRU may detect that the measured value(s) are above a threshold for one or more of the configured reporting sub-bands. The WTRU, e.g. based on its capability, may detect that the measured value(s) are above a threshold for a set of RBs that is a subset of the configured resources or reporting subband. The WTRU may evaluate sets of RBs based on a received (pre)configuration about the RB-based support and granularity and/or reported capability. The WTRU may detect that some RBs of a reporting subband/wideband configuration are beyond a corresponding threshold, while the average over all the resources of the reporting subband/wideband configuration is below the threshold. In an example, the WTRU may report to the network its capability to support and perform RB-level (e.g., RB-set-level, RB-group-level) detection of CLI, and reported one or more granularity (e.g., down to 1 RB). The WTRU further received configuration from the network enabling and configuring the RB-based measurement, at least for some CLI measurement resources/configurations. The WTRU, performing the measurement, may detect that some RBs, e.g., 2 consecutive RBs within a given reporting subband, exceed the corresponding threshold, and identify the RBs based on their position and the corresponding reporting subband index. The WTRU may detect that some RBs are beyond the corresponding threshold, for one or more sets of RBs within the configured CLI measurement resources. For example, the WTRU received a CLI measurement configuration including resources spanning an entire SBFD subband, and may detect CLI in some RBs at both edges of the subband. Based on the (pre)configuration, one or more thresholds may apply to the different cases and situations, e.g., based on whether the measurement is wideband, or narrowband. Multiple thresholds may also be configured for a given situation, to evaluate different levels of CLI.

The WTRU may trigger the dynamic guard-band procedure based on the detection of resources above a CLI threshold and on the received configuration.

The WTRU may determine the resources (e.g., a set of REs/RBs and on which to apply the dynamic guard-band, based on the CLI measurements and received configuration. In some examples, which may be combined. The WTRU may determine based on the (configured) association between a CLI measurement and a SBFD subband. For instance, the CLI measurement triggering the dynamic guard band may be associated with a SBFD subband, and the WTRU may determine the subband on which the dynamic guard-band applies based on that association. It may be the subband which the resources of the CLI measurement are configured, or it could be the adjacent subband. The WTRU may determine the resources on which to apply the guard band based on the configured association between the CLI measurement triggering the dynamic guard-band and set of resources within a sub-band. The WTRU may determine the resources on which to apply the guard band based on the configured association between the resources within the CLI measurement resources triggering the dynamic guard-band and a set of resources within a sub-band. The WTRU may determine the resources on which to apply the guard band based on the resources of the CLI measurements being beyond the corresponding threshold, e.g., the RB-based, subband-band or wideband based resources of the measurement. The WTRU may determine the resources on which to apply the guard band based on the resources of the CLI measurements being beyond the corresponding threshold and the received configuration of the neighboring cell, and where the WTRU may determine the resource overlap of UL/DL sub-bands. The WTRU may determine to use the UL/DL subband overlapping resources, if the measured CLI beyond the threshold are overlapping or included in the DL/UL neighboring configuration overlap. The set of resource for the dynamic guard-band may be selected based on an RB size or multiple of an RB size that the WTRU reported as capability and/or received as (pre)configuration. In some cases, e.g., in the case of OFDM-based transmissions, the WTRU may be able not transmit in any REs/RBs in the physical resources (while transmitting in the others at the same time), by not transmitting the corresponding REs/RBs. Thus, the WTRU may select any set of resource for the dynamic guard-band that correspond to above criterions. In some cases, e.g., in the case of DFT-FDM transmissions, the WTRU may be able to only transmit contiguous set of RE/RBs, e.g., the dynamic guard-band can only be located at the edge of the (sub)band. Thus, the WTRU may determine a set of resources for the dynamic guard-band that is contiguous and on the edge of the (sub)band that correspond to above criterions.

The WTRU, based on (pre)configuration, may select the method to apply for the dynamic guard-band procedure, which may, for example, be one of puncturing, rate-matching or cancelling a transmission on a set of resource. The WTRU may select the (pre)configured default methods (e.g., puncturing) if no other method has been indicated for the triggering CLI and/or guard-band resources. The WTRU may select the method based on the whether the WTRU already reported the CLI measurement or not. Based on (pre)configuration, the WTRU may select a first method if it didn't report the CLI/dynamic guard-band (yet) and a second method after reporting. The WTRU may select the method based on the WTRU conditions and (pre)configuration, e.g., based on the WTRU capability, CLI threshold(s), number of RB in the guard band, Signal quality, etc., as described above.

The WTRU, based on (pre)configuration, may report the triggering/activation of the dynamic guard-band. The reporting may be sent to the using UCI, MAC CE or RRC indications. The report may include indications for the following. The starting/activation of the dynamic guard-band procedure/feature may be included. The starting/activation may also indicate a time delay or timer used to indicate after what time the dynamic guard-band is actually activated (to give time to prepare). The determined resources for the dynamic guard-band may be included. The WTRU may indicate the resources by indicating the index of the RBs selected and/or the corresponding subband. In an example, the WTRU may indicate the subband index and/or the BWP ID and an index of a starting and ending RB within the subband. In an example, the WTRU may indicate the subband index and/or the BWP ID and an index of a starting RB and a number of RBs or number of the RB granularity. In an example, the WTRU may indicate the neighboring cell with which it has a UL/DL subband overlap and implicitly indicate that the selected resources correspond to the overlap. In an example, if the determined resources is deterministic based on other reported information, e.g., if the resources are directly associated with a CLI trigger, this information may be omitted.

The measurement values, such as the (L1-)CLI-RSSI, (L1-)SRS-RSRP or (L1-)CSI-IM values, for the configured measurement resource and reporting, e.g., wideband or subband may be included. The measurement values, such as the (L1-)CLI-RSSI, (L1-)SRS-RSRP or (L1-)CSI-IM values, for the determined subset of RBs for which the CLI is above the threshold may be included. The trigger (e.g. based on configuration ID) and/or the threshold used/passed for the measurement and that triggered the dynamic guard-band. The selected method, which may be one of puncturing, rate-matching, cancelling. The selected method may not be reported if it is deterministically configured by the network, e.g., based on other conditions.

The corresponding time resources may be included. The WTRU may have determined the CLI resources for some time resources, not all of the time resources, and may indicate which are affected. For example, indicating the slot and symbol indices in the duplexing pattern period.

The corresponding beam may be included. The WTRU may indicate the RX beam used for the CLI measurement, e.g., using a reference to a beam used for receiving other signals or channels or a UL TX beam (e.g., based on an SRS beam), to the network.

The WTRU may send a CLI report, e.g., triggered by the measurement over a threshold, and implicitly indicate to the network that the dynamic guard-band associated with that CLI measurement is activated. The report may be sent jointly with the CLI report, some information may be common between the CLI report and the dynamic guard-band report and can be reused. However, if some elements are different, they may be explicitly indicated. For example, the trigger for CLI measurement report and the trigger for dynamic guard-band may use different thresholds, the resources configured for the CLI measurement and the resources for the dynamic guard-band may be different, the WTRU may include an explicit indication in the CLI report whether the CLI report triggers the activation of the dynamic guard band and the report may be sent jointly with another UL transmission, e.g., the first transmission where the dynamic guard band is applied; or an transmission ahead of the starting time of the dynamic guard band.

The WTRU may be (pre)configured with a procedure on whether to wait for the network to confirm the dynamic guard-band activation or whether the WTRU may activate it based on its own actions (e.g., after the WTRU reports to the network). In an example, the WTRU is (pre)configured so that no network confirmation is needed to activate the dynamic guard band. For example, the dynamic guard-band is activated based on the WTRU reporting (CLI reporting and/or guard-band determination reporting). In this example, the WTRU applies the dynamic guard-band reporting configuration based on the default configuration and/or the information/configuration reported to the network (e.g., guard-band time/frequency resources, methods, conditions, etc.). In an example, the WTRU is (pre)configured to receive an indication from the network (e.g., via RRC, MAC or DCI) to confirm/validate/enable the activation of the dynamic guard-band.

The WTRU may adopt the following behaviors. The WTRU may wait for the reception of the indication to activate the dynamic guard-band, i.e., does not apply the dynamic guard-band behavior before receiving the confirmation. After receiving the confirmation indication, the WTRU may use the dynamic guard-band configuration based on the network indication and WTRU reports. The WTRU may apply a first dynamic guard-band configuration before receiving the network indication, and apply a second configuration after receiving the indication. The first indication may be a default configuration while the second configuration may be based on the WTRU report information and network indications. The WTRU may start a (pre)configured timer, when reporting the dynamic guard-band to the network, and if the network did not confirm before the timer expires, the WTRU assumes that the network rejected and does not apply the dynamic guard-band behavior.

The network indication/confirmation may include the following. A validation of the dynamic guard-band configuration and information reported by the WTRU. I.e., a bitflag indication that the WTRU may use the determined configuration and/or default configuration. A rejection, where the network indicates that the WTRU shall not apply the determined configuration. A reconfiguration of some parameters may be included. The network may indicate that some parameters may be changed compared to the ones reported by the WTRU or the defaults. The WTRU may also have reported a set of options for the dynamic guard-band configuration, from which the network selects from. The WTRU uses the reconfiguration parameters for the application of the dynamic guard-band, i.e., overriding the previously determined or indicated (pre)configuration. For example, the WTRU may receive another set of resources on which to apply the dynamic guard-band, compared to the one the WTRU reported. The WTRU may receive an indication of which method(s) (puncturing, rate-matching, cancellation etc.) to use for the dynamic guard-band. The WTRU may receive an indication of conditions on how to select the method. The WTRU may receive an indication of the exemptions to the dynamic guard-band. The WTRU may receive indications about the timers, start and stop conditions for the dynamic guard-band. For example, a duration for which the current dynamic guard-band applies. The WTRU may receive indications on which time resources the dynamic guard-band applies, e.g., a set of symbols/slots or a repeating time pattern.

The WTRU may receive indications about a transmission grant or assignment, including the time/frequency resource allocation of the transmissions and the corresponding properties (cf. properties described above). The WTRU may receive an UL grant or assignment for PUSCH/PUCCH transmission, which may be periodic or semi-persistent and configured with a periodicity, such as a Configured Grant; or aperiodic. The grant or assignment may include repetition indications and resources. For periodic/semi-persistent transmissions, some of the transmissions may be on time resources where the dynamic guard-band applies, while other may be on time resources where the dynamic guard-band does not apply. The WTRU may receive or be (pre)configured with an UL grant or assignment for RS or control transmissions such as for SRS or PRACH transmission. The grant/assignment may be received before the dynamic guard-band triggering or reporting, while the assignment may include resources after the reporting/triggering of the dynamic guard-band, e.g., for periodic/semi-persistent grants, repetitions etc. The grant/assignment may be received after the dynamic guard-band triggering or reporting, and include resources of the dynamic guard-band.

The WTRU may determine that some of the time/frequency resources of the assigned/granted transmission overlap with the dynamic guard-band. The WTRU may identify the set of REs/RBs that are affected, i.e., overlapping the dynamic guard-band. The identified resources (REs/RBs) may be a set of REs or RBs in the frequency domain that are constant in the time domain. In an example, the WTRU received an assigned transmission with a frequency allocation of 5 RBs in the frequency domain over a slot in the time domain, while the dynamic guard-band covers one of the RB for the whole slot. Therefor the WTRU determines the set to be that RB over a slot. The identified resources (REs/RBs) may be a set of REs or RBs in the frequency domain that vary over time. In an example, the WTRU received an assigned transmission with a frequency allocation of 5 RBs in the frequency domain over a slot in the time domain. The dynamic guard-band covers 2 RBs of the assigned resources in some symbol(s) of the slot, and 4 RBs in the others (not necessarily contiguous).

The WTRU may then determine if, based on the (pre)configuration, the WTRU may apply the dynamic guard-band behavior (e.g., the selected method such as puncturing/rate matching) to the resources of the assignment. The WTRU may check the assignment based on configured exceptions. The conditions may be based on the assignment or transmission itself and the conditions on the WTRU situations. For example, data priority may be used if the transmission has a priority higher than a threshold, it may be exempted of the dynamic guard-band. For example, latency/QoS may be used if the transmission has a latency or remaining delay budget is below a threshold, it may be exempted of the dynamic guard-band. For example beams may be used if the transmission is configured with a beam different than the one used for the measurement of the CLI or if the beam is not included in a set of beams for the dynamic guard-band, it may be exempted of the dynamic guard-band. For example channel type may be used if the WTRU is configured to apply the dynamic guard band on PUSCH transmission, and if the transmission is for a PUCCH, SRS or PRACH, it may be exempted of the dynamic guard-band. Periodic/aperiodic may be used if the WTRU is (pre)configured to apply the dynamic guard-band only on periodic transmissions and if the assignment is a dynamic grant, it may be exempted of the dynamic guard-band. Retransmission may be used if the assignment includes retransmissions and one or more of the retransmissions is outside of the guard band resources, it may be exempted of the dynamic guard-band. Transmission content may be used if the WTRU is configured to not apply the dynamic guard-band if the transmission is a UCI, includes a UCI, includes an ACK/NACK, includes CSI/CLI report, or includes a MAC or RRC signaling, etc. and if the transmission includes one of the exempted content, it may be exempted of the dynamic guard-band. WTRU conditions may be used for a WTRU in the cell center or not in the cell edge may be exempted of performing the dynamic guard-band.

Conditions may include CSI/channel quality from the serving cell, transmission parameters, location, light-of-sight, for example. CSI/channel quality from the serving cell may be used, e.g., if the WTRU measures the serving cell, e.g., CSI-RS or SSB-based RSRP/RSRQ, RSSI, or SINR is higher than a threshold, the WTRU may not apply the dynamic guard-band. Transmission parameters, such as MCS, code-rate, number of layers, etc., may be used if the WTRU is configured with such transmission parameter above a threshold, the WTRU may not apply the dynamic guard-band. Location may be used if the WTRU, using its location (e.g., absolute/relative to the cell), determines that it is at a distance lower than a threshold, the WTRU may not apply the dynamic guard-band. Light-of-Sight (LOS) may be used if the WTRU is in LOS with the serving cell, the WTRU may be not apply the dynamic guard-band. The WTRU may apply the dynamic guard-band on the transmission if the assignment was received before (e.g., a configured time-domain offset before) the trigger, reporting, or activation of the dynamic guard-band, but may exempt the assignments receive after (e.g., a configured time-domain offset after), e.g., considering that the network sent the assignment to the WTRU knowing that the WTRU is experiencing CLI.

The WTRU may apply a determined/indicated method (e.g. puncturing, rate-matching, cancellation) to perform the transmission of the assigned/granted transmission, based on the determined set of resources in the dynamic guard-band.

The WTRU may determine or be configured/indicated to use one of the methods. When using the puncturing method, the WTRU prepares the transmission of the data as if the assigned transmission resources are all available, e.g., determining the transport block size (TBS), MCS, rate-matching, resource mapping, etc. But it cancels the transmission of the (physical) REs/RBs that are identified in the dynamic guard-band. The transmission is therefore “incomplete”, but the network may still decode the transmission if a limited part of it is missing (e.g., due to channel coding, redundancy etc.) or if the transmission is split into independent segments. With rate-matching, the WTRU may consider the missing resources in the determination of the transport block and adapt the transmission parameters to include the intended data in the remaining resources. For instance, the WTRU may increase the data rate by discarding some bits of the transmission (e.g., redundancy bits). The WTRU may cancel the transmission of the data if some of the configured/granted resources are overlapping with the CLI-identified resources. The WTRU may be (pre)configured with priorities on the content to transmit (e.g., ACK/NACKs, UCI, data payload, CSI feedback etc.), and in the case where the transmission has resources overlapping with the dynamic guard-band and/or if the data rate of the transmission on the remaining resources exceed a threshold, the WTRU may discard/cancel the transmission of one or more of the multiplexed transmission data (e.g., discard the lower priority content first). The WTRU may have been indicated with the method to use, either by default or by receiving the configuration for that CLI trigger/guard-band configuration.

The WTRU may determine the method to apply for the dynamic guard band on this transmission based on transmission type and transmission success likelihood. The WTRU may receive the (pre)configuration that some transmissions are to be using one method and some other types of transmissions other methods. For example, the WTRU may receive the (pre)configuration that PUCCH transmissions may only use the rate-matching, while PUSCH may use puncturing. The WTRU may receive a (pre)configuration to evaluate the transmission success likelihood base on the assignment and determined set of resources to mute. The likelihood of success may depend on, for example, the transport block size, the modulation, number of assigned resources, number of resources overlapping the guard-band, channel conditions, number of layers, etc. In an example, the WTRU may determine the ratio of resources muted compared to the total number of resources assigned and, based on for example a threshold, use a first method or a second method.

The WTRU may also determine a transmit power on the remaining transmit resources (outside of the dynamic guard-band), where the WTRU performs the transmission using the total power intended to the original transmission, but over fewer transmission resources, effectively increasing the transmission power per active resources. This transmit power is therefor time resource specific (e.g., symbols/slots on which applies the dynamic guard band) and also sub-band/SBFD pattern specific.

The WTRU, having received the transmission assignment, may perform the transmission, based on the received assignment or configuration, and based on the dynamic guard band and the determined transmission preparation. In an example, the WTRU received or is preconfigured with a transmission whose resources are outside of the dynamic guard band, and the WTRU transmits it normally. In an example, the WTRU received or is preconfigured with a transmission with resources overlapping the dynamic guard-band, but that is exempted from applying the dynamic guard-band, e.g., based on QoS, transmission type, etc. In an example, the WTRU received or is preconfigured with a transmission with resources overlapping the dynamic guard-band, and the WTRU transmits the REs/RBs of the transmission located outside of the dynamic guard-band, but does not transmit the REs/RBs in the dynamic guard-band.

The WTRU may include an indication, jointly with the transmitted data (e.g., as a UCI, bit field) for the method and parameters used for the transmission, and/or include the dynamic guard-band reporting. In an example, if the WTRU determined a transmission specific method or method parameter, the WTRU may include that information in an indication jointly transmitted with the data. In an example, if the WTRU didn't report the dynamic guard-band (yet) to the network, the WTRU may jointly report the trigger/dynamic guard-band parameters together with the data.

The WTRU may receive an indication to activate or deactivate the dynamic guard-band from the network, instead of activating the dynamic guard-band directly based on WTRU's measurements and triggers. The WTRU may receive from the network an indication of a set of resources, in both time and frequency domains. These resources may be explicitly indicated or may correspond to subband edges, overlaps in subband configuration between different cells in the network, etc. The resources may also be associated with an ID. The WTRU may further receive an indication, e.g., with a DCI, MAC or RRC signaling, indicating the activation of a dynamic on the set of resource. The WTRU then activates the dynamic guard-band on the indicated resources, and perform similar transmission preparation as described previously. The network may send the dynamic guard band activation indication based on an indication that the WTRU sent to the network, e.g., based on a CLI/CSI report and/or dynamic guard-band activation request. The WTRU may receive a deactivation indication, after which the WTRU no longer applies the dynamic guard-band and related behavior. The activation and/or deactivation may be for one or more sets of resources, and not necessarily for all of the (in) active guard bands over different sets of resources.

The WTRU may (de) activate the dynamic guard-band using a (pre)configured timer and/or a time offset to control and give the WTRU and the network time to prepare and change their behavior. The time offset or timer may start when, e.g.: the WTRU performed the measurement triggering the dynamic guard-band, the WTRU reports the dynamic guard-band activation to the network, the WTRU receives a feedback for the reporting of the dynamic guard-band activation from the network, and the WTRU receives the (de)activation indication from the network.

The WTRU may deactivate the dynamic guard-band, at least on some of the set of resources, and whether the activation was WTRU initiated or network initiated, based on one or more of the following (the WTRU may have received the (pre)configuration of the conditions from the network) using the new CLI measurement, reconfiguration, beam change, and timer expiration. In an example, the WTRU perform a CLI/CSI measurement after the activation of the dynamic guard band, e.g., one that is associated with the dynamic guard-band configuration, and the measurement no longer passes the associated threshold that triggers the dynamic guard-band. The WTRU may be configured with two different thresholds, one for the activation and one for the deactivation, to avoid changing the configuration too often. In an example, the WTRU may receive a (re)configuration, e.g., through RRC, MAC or DCI signaling, indicating a change in the configuration of the SBFD sub-bands (e.g., the frequency size and position of the sub-bands, their timing configuration etc.). The WTRU may assume that the network reconfigured it to avoid the CLI and thus no longer applies the dynamic guard band. In another way, the WTRU may check if the new SBFD configuration still has resources in the dynamic guard band, and if not, may deactivate the dynamic guard-band. The WTRU received a command of changing the serving cell and may no longer apply the dynamic guard-band. The WTRU changes the spatial filter associated with UL transmissions and/or DL receptions, e.g., after the WTRU performed a CSI measurement or after the WTRU received an indication from the network configuring the beam/spatial filter to use for a transmission. The WTRU may be (pre)configured with a timer duration for which the WTRU applies the determine/indicated dynamic guard-band. When the timer expires, the WTRU deactivate the dynamic guard-band. The timer may be (re)started when, e.g., the WTRU performed the measurement triggering the dynamic guard-band, the WTRU reports the dynamic guard-band activation to the network, the WTRU receives a feedback for the reporting of the dynamic guard-band activation from the network, the WTRU (effectively) activates the dynamic guard-band, and the WTRU receives the activation indication from the network.

The WTRU may report to the network the deactivation of the dynamic guard-band, e.g., by UCI, MAC or RRC signaling. The WTRU may report when the deactivation is WTRU-initiated and/or when timers may be restarted by the WTRU (e.g., when the network does not have a deterministic time for which the WTRU deactivates the dynamic guard-band.

The WTRU may determine the resources for which the dynamic guard-band applies, based on the configured measurement and resource association. The WTRU, as described above, may determine a set of REs/RBs over which to apply, but can also or alternatively determine other aspects reusing the same principles (e.g., different wording or configuration change but same practical effects), and then report and use these versions of resource for the behavior described above. The WTRU may determine a frequency position and size of the SBFD sub-bands (UL and DL), that may be reduced compared to the configuration the WTRU received from the network. This implicitly determines the guard-band (as the resources between adjacent sub-bands). The WTRU may determine that a subband is not usable, e.g., due to the CLI measurement passing the threshold, at least on some time resources, and considers the whole subband as a dynamic guard-band. The WTRU may determine a frequency position and size for a BWP (UL or DL), that may be reduced compared to the configuration the WTRU received from the network. The WTRU may report the corresponding BWP configuration to the network. The WTRU may determine a set of (pre)configured BWP that are not usable, e.g., due to the CLI measurement passing the threshold, at least on some time resources, and report a set of usable/non-usable BWPs to the network, e.g., based on their BWP index. The WTRU may be (pre)configured with a set of SBFD subband patterns (e.g., multiple SBFD configurations), and determine which patterns are usable or not usable, e.g., based on the measurements. The WTRU may report to the network the set of (un)usable SBFD patterns. The WTRU may determine a (sub)set of usable PRBs, from the set of “usable PRBs”, by excluding the resources otherwise described as determined for the dynamic guard-band.

The WTRU may determine whether to apply the dynamic guard-band after the transmission of its report to the network or wait for network confirmation depending on. The WTRU may receive a network (pre)configuration indicating whether the WTRU should wait for a network confirmation to apply the dynamic guard-band, or if the WTRU may apply based on its measurement and after reporting. The WTRU may also be (pre)configured with conditions for which to apply the dynamic guard-band directly or to wait for the network confirmation based on traffic and data QoS, size of the guard-band, UL/DL sub-bands, selective BWP/sub-bands, and selective CLI trigger/resource association.

Based on traffic and data QoS, the WTRU may want to avoid restricting the transmission resources for important data. For example, if the WTRU may have data pending in the queue for the subband direction (e.g. UL) and based if the priority of the data is higher than a threshold, or latency is below a threshold, or if QoS requirement is strict, the WTRU may determine to report this to the network and wait for the network confirmation to applies the dynamic guard-band.

Based on size of the guard-band, the WTRU may want to avoid a sever reduction of resources for some BWP/sub-bands. For example, if the measurement and resource determination lead to a dynamic guard-band exceeding a number of REs/RBs (threshold) or if the size of the BWP or subband remaining is below a threshold (absolute or relative), the WTRU may determine to report this to the network and wait for the network confirmation to applies the dynamic guard-band.

Based on UL/DL sub-bands, the WTRU may apply different behavior depending on if it is receiving the CLI (i.e., on the DL subband) or if it is generating CLI to others (UL sub-band). In an example, the WTRU may be (pre)configured to directly apply the dynamic guard-band on the UL subband while it may wait for the network confirmation/reconfiguration for the DL subband.

Based on selective BWP/sub-bands, the WTRU may be configured with indications for which BWP and/or sub-bands it may apply the dynamic guard-band and/or on which the WTRU may report and wait for (re)configuration to apply the dynamic guard-band.

Based on selective CLI trigger/resource association, the WTRU may be configured, together with the CLI-base measurement/triggers or the association of resources between the trigger and the resources for the guard-band, with an indication of whether that measurement/trigger require a feedback from the network or may apply based on the WTRU report.

The WTRU may receive (re)configuration of some other cell/transmission parameters, e.g., jointly with the confirmation/validation of the dynamic guard-band, and/or triggered by the WTRU report. The (re)configured parameters may include a change of SBFD configuration, a beam change and CSI/CLI measurement and reporting reconfiguration. For a change of SBFD configuration, the WTRU may receive a reconfiguration of the SBFD pattern, subband position and size, at least for some time resources. The SBFD pattern/configuration may have been one of a (sub)set of SBFD pattern/configuration that the WTRU reported to the network, based on the CLI measurement. For a beam change, the WTRU may report one or more beams (e.g., as QCL type D indications) e.g., based on the CLI measurement using different beams to evaluate which beams are subject to CLI or not. The network may reconfigure/indicate to the WTRU to use one of the reported beam instead of previous beams. For CSI/CLI measurement and reporting reconfiguration, the WTRU may receive a new or updated configuration of the CSI/CLI measurements, based on the CLI/guard-band report. For example, the reconfiguration may include subband reporting or CLI/CSI resources corresponding to the reported resources that the WTRU determined the CLI/guard-band. The CSI/CLI reporting condition may also be changed, such as the periodicity of report, triggers and thresholds, so that the WTRU may more accurately report CLI/CSI on some specific resources.

The WTRU may receive from the network a reconfiguration of parameters beyond the dynamic guard-band, in response to the CLI report and/or the dynamic guard-band trigger/activation report. The parameters may include one or more of beam change, BWP/SBFD configuration change and CSI/CLI measurement and reporting configuration change. For a beam change, the WTRU may receive an indication to perform transmissions using another (set of) beam(s), e.g. by indicating another spatial filter to apply to transmissions, e.g. by using the QCL reference to another RS (e.g. QCL Type D). The WTRU may receive the beam as secondary beams to use in replacement of the regular beam when the resources are overlapping with the dynamic guard-band. For a BWP/SBFD configuration change, the WTRU may receive the indication to use another BWP/SBFD configuration, e.g., another SBFD pattern, another frequency size and/or position of one or more sub-bands or of BWP, and the associated time resources on which to apply it. For a CSI/CLI measurement and reporting configuration change, the WTRU may receive a configuration for a CSI measurement and reporting, based on the reported CLI/guard-band and the corresponding resources. For example, if the WTRU reported a CLI/dynamic guard-band over a set of RBs within a reporting CSI/CLI measurement resource, the network may configure to have a measurement and reporting corresponding to these resources, e.g., by changing the size of the subband reporting, the resources of the CSI/CLI measurements, and/or changing the triggers/thresholds associated to it.

The network may indicate if the given additional (re)configuration maintains the dynamic guard-band active or if it deactivates it (i.e., replaced by using other cell/transmission configurations). The WTRU, receiving such indication, may activate or deactivate the dynamic guard-band accordingly. In an example, the WTRU, together with the CLI/dynamic-guard band report, further reported one or more configurations of parameters that the WTRU determined to be suitable to avoid the CLI. The WTRU may then receive from the network one of the reported configurations (which may be indicated by an index from the WTRU report). For example, the WTRU may measure the CSI/CLI using multiple receive beams, and report, jointly with the CLI measurement using the scheduled beam, the set of beams that have low CLI and/or the set of beams with a high CLI. The beams may be reference with the corresponding QCL'ed RS. The network may then select one or more of the reported beam to indicate which beam the WTRU should use.

The WTRU may perform a first UL transmission based on a first assignment, where some resources are overlapping the dynamic guard-band, and the WTRU further receives a second assignment for a repetition of the first UL transmission. If the repetition has resources overlapping the dynamic guard-band, the WTRU may exempt the second UL transmission from applying the guard-band and perform the transmission as requested by the network.

The WTRU may be (pre)configured to perform a second (aperiodic) CSI/CLI measurement and report (e.g., using L1-CLI-RSSI, L1-SRS-RSRP, L1-CSI-IM etc.) after the dynamic guard-band activation, where the WTRU perform a second measurement on the resources of the dynamic guard-band (e.g., the set of determined RBs) and reports the CLI and conditions on the determined resource, to help the network in maintaining the guard-band and cell configurations. The second measurement and reporting may be triggered by one or more of the following. Triggering may occur when the WTRU performed the first measurement which is beyond the configured threshold. Triggering may occur when the WTRU activated/reported the dynamic guard-band. Triggering may occur when the WTRU received indication to activate or confirming the activation of the dynamic guard band. Triggering may occur when the WTRU received a reconfiguration of the dynamic guard-band frequency resources. Triggering may occur when the WTRU received a reconfiguration of the time/frequency resources of the SBFD sub-bands and/or BWPs. Triggering may occur when the WTRU received a reconfiguration of the CLI/CSI measurement and reporting configuration, e.g., where the resources or reporting sub-bands indicate the resources in the dynamic guard-band. Triggering may occur when the WTRU received an explicit command from the network to perform the (aperiodic) CSI/CLI reporting, e.g., with subband reporting request. The granularity of the subband may be different from the originally configured CSI/CLI measurement and reporting. The granularity and/or position of the resources may correspond to the resources determined for the dynamic guard-band. Triggering may occur when the WTRU measured the CSI/CLI that did not pass the threshold.

The WTRU, when performing a CLI measurement over the configured resources (e.g., wideband or reporting subband L1-CLI-RSSI or L1-SRS-RSRP or L1-CSI-IM), may perform a progressive RB-level subset determination. For example, the WTRU may refine the granularity of the measurement on specific (part) of the configured resource to perform selective precise measurements, and/or may remove some specific RB-level subset(s) in performing the CLI measurement and reporting (e.g., the subset(s) not adjacent to (or at least Y-RB far away from) the dynamic guard-band). Removing the specific RB-level subset(s) may provide benefits in terms of resource overhead reduction for the reporting and WTRU measurement complexity reduction, while the second measurement and reporting may be better (efficiently) focused around the dynamic guard-band. For example, in a first measurement, the WTRU measured a 32 RB measurement that passes the threshold, on a second measurement, the WTRU split in 4 sets of 8 RBs and measures one of them passing the threshold, and may further refine afterwards until the configured or capable minimal granularity is reached. In an example, the WTRU is (pre)configured with two measurements and reporting configurations (e.g., one with wideband and one with sub-bands based reporting). The WTRU first performed a wideband CLI measurement that passes the associated threshold and triggers a switch of configuration to then perform a subband-based measurement and reporting.

The WTRU may be (pre)configured with a trigger on a CSI/CLI measurement and report configuration, where the trigger is associated with a first threshold on the average power over all the resources (e.g., (L1-)CLI-RSSI, (L1-)SRS-RSRP, (L1-)CSI-IM) and a second threshold measuring the frequency-selectivity of the CLI, e.g., being represented by a threshold on the variance or standard deviation of the power on the resources. That way, the WTRU may report a strong CLI on a wideband even if the average CLI is below the threshold.

A dynamic guard-band may be used for a DL subband and DL transmissions. In complement, or alternatively, to the solutions and complementary aspects presented so far that mainly focusing UL, the WTRU may also determine a dynamic guard-band for a DL subband and DL transmissions. The WTRU determination may be based on, e.g., CLI measurements and triggers. The aspects and methods described herein may apply to a dynamic guard-band over the DL subband. This includes, for example, replacing UL subband by DL sub-bands, UL channels by their corresponding DL channels, UL signals or transmission by their DL corresponding signals or transmissions and so on.

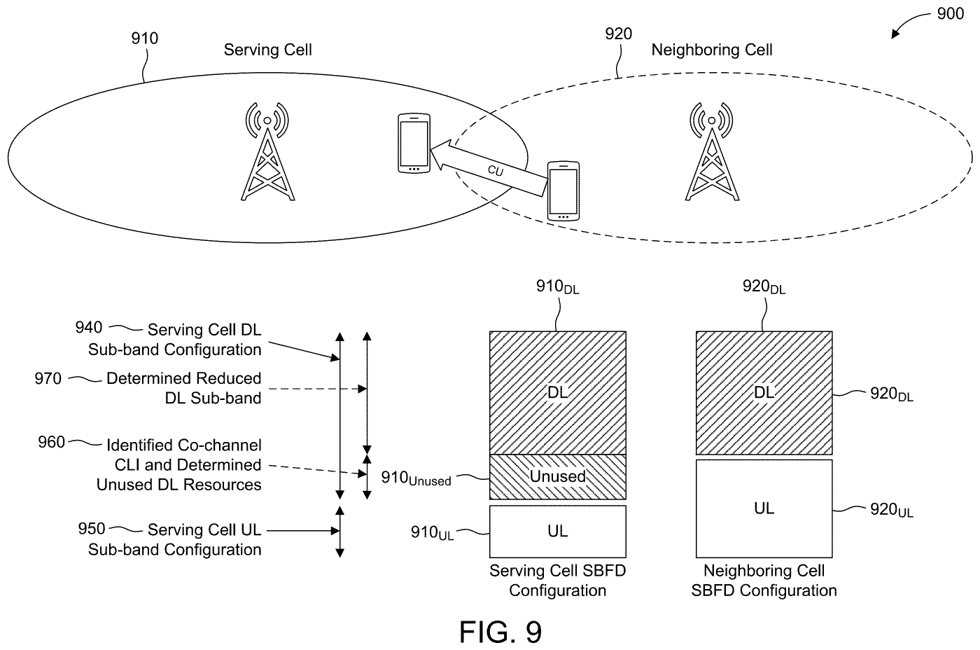

FIG. 9 illustrates an exemplary WTRU-based configuration 900 where the WTRU does not use overlapping resources in its DL subband. Configuration 900 includes a serving cell 910 and a neighboring cell 920. Serving cell 910 includes a DL 910_{DL}, an UL 910_{UL}, and an unused portion 910_{UNUSED}. Neighboring cell 920 includes a DL 920_{DL} and an UL 920_{UL}. As described above, there is a serving cell DL sub-band configuration 940 and a serving cell UL sub-band configuration 950. As illustrated in configuration 900, serving cell DL sub-band configuration 940 is divided into DL 910_{DL} illustrated as determined reduced DL sub-band 970 and unused DL resources 910_{UNUSED} illustrated as identified co-channel CLI and determined unused DL resources 960. As illustrated in configuration 900, serving cell UL sub-band configuration 950 corresponds to UL 910_{UL}.

The WTRU may report the CLI associated with DL resources and/or the activation/trigger of the dynamic guard-band applied on DL resources, and the WTRU further may apply the dynamic guard-band reception methods on the DL. Similar to UL, the DL dynamic guard-band (de)activation may be subject to network confirmation, timers and conditions as described previously. The WTRU may further trigger the DL dynamic guard-band based on a CSI/CLI measurement being above a threshold and/or the reception of DL transmissions, where the signal quality of the DL transmission is lower than expected. For example, if the WTRU has a good channel quality (e.g. a SINR/CSI-RS above a threshold) and configured with a low data-rate transport format (e.g., MCS/layers below a threshold) but the decoding failed, the WTRU may determine an unexpected interference. For example, the WTRU may perform DL receptions and detects that, for a specific set of resources, the decoding fails and the WTRU reports one or more NACKs. For example, the WTRU may perform RB-level measurement of the DMRS included in the DL transmission (e.g., PDSCH-DMRS, PDCCH-DMRS, etc.) and evaluates that parts of the resources of the DMRS have a strong interference, e.g., some REs/RBs of the DMRS have a SINR below a threshold.

The WTRU may receive a DL grant or assignment, including the DL resources and transmission parameters (QOS, transport format, . . . ) and the reception may be periodic, semi-persistent or aperiodic/dynamic. For periodic/semi-persistent transmissions, some of the transmissions may be on time resources where the dynamic guard-band applies, while other may be on time resources where the dynamic guard-band does not apply. The WTRU may be (pre)-configured with different receptions methods. Methods include cancellation, regular reception, and partial reception, for example. For cancellation, the WTRU may cancel and not attempt to receive the granted DL assignment, where some of the resources are overlapping with the DL dynamic guard-band. For regular reception, the WTRU may perform a regular DL reception of the granted DL assignment, knowing that some resources are likely to have strong CLI. For partial reception, the WTRU may perform the reception only over the resources outside the dynamic guard-band, assuming that the network adapted the transmission and/or “puncturing” the reception. The WTRU may be able to perform/attempt some decoding assuming different parameters if not (pre)configured by the network, for instance, the WTRU may assume that the network performed resource puncturing, rate-matching or that the network didn't change the transmission and the WTRU still attempts a regular decoding with missing resources.

The WTRU may select the method for the DL dynamic guard band based on network indication and similar UL conditions, for example. For network indication, the WTRU may have received (pre)configuration and/or indication in the dynamic confirmation and/or indication in the DL grant/assignment of which method to select for the dynamic guard-band and/or for this particular transmission. For similar to UL conditions, the WTRU may also select the method based on CSI/CLI measurement, reports or threshold; number of resources in the dynamic guard-band compared to the number of resources in the assignment or compared to the number of resources in the subband/BWP; WTRU capability; etc.

The WTRU may be (pre)configured with exceptions or specific configurations for some DL transmission, signals or channels, for which the WTRU received an association with a method or an exemption of application of the DL dynamic guard-band. For example, and similarly to the UL version, the WTRU may apply the DL dynamic guard-band on PDSCH and/or PDCCH, but not on PBCH, SSB, RS measurements, etc. any combination may apply, the WTRU may exempt some reception of the DL dynamic guard-band on transmissions based on data QoS, e.g., if the remaining latency is below threshold, if the priority is higher than a threshold, etc., the WTRU may exempt receptions from the dynamic guard-band if WTRU conditions such as Channel quality, distance to cell center, MCS/number of layers etc. are passing some thresholds.

The WTRU may report to the network a feedback for the DL reception (e.g., an ACK/NACK) where the WTRU further indicates the activation of the dynamic guard-band, and/or the method used for the DL reception.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed in a wireless transmit/receive unit (WTRU) comprising:
receiving a duplexing sub-band full duplex (SBFD) configuration information from a serving cell, the SBFD configuration information including a guard-band configuration associated with cross link interference (CLI) measurements, and a CLI threshold;
determining that a measured CLI exceeds the CLI threshold;
based on the determination that the measured CLI exceeds the CLI threshold, determining a set of resource blocks (RBs) to use as a first guard-band;
performing an uplink (UL) transmission comprising the first guard-band by puncturing the determined set of RBs, wherein the UL transmission comprises reporting information on at least one of the punctured determined set of RBs used as the first guard band and the measured CLI; and
receiving an indication from a network acknowledging the reporting information.

2. The method of claim 1 wherein the SBFD configuration information is based on a capability of the WTRU.

3. The method of claim 1 wherein the SBFD configuration information further includes CLI measurement configuration information and a reporting configuration.

4. The method of claim 1 wherein the guard-band configuration associated with CLI measurements comprises a trigger associated with the CLI threshold.

5. The method of claim 1 wherein the guard-band configuration associated with CLI measurements comprises a guard-band granularity value.

6. The method of claim 1 wherein the guard-band configuration associated with CLI measurements comprises an indication to perform partial transmissions overlapping the set of RBs to use as the first guard-band.

7. The method of claim 1 further comprising receiving a resource allocation for transmissions.

8. The method of claim 7 wherein the resource allocation for transmission includes an UL periodic grant.

9. The method of claim 8 wherein the UL periodic/configured grant comprises at least one of radio resource control (RRC) reconfiguration, medium access control (MAC) control element (CE) activation, or downlink control information (DCI).

10. The method of claim 1 wherein determining a set of RBs to use as the first guard-band includes a size and a position of the first guard-band corresponding to one or more RBs of the set of RBs exceeding the CLI threshold.

11. The method of claim 1 wherein receiving an indication from the network acknowledging the reported information comprises an updated SBFD sub-band configuration.

12. The method of claim 11 wherein the updated SBFD sub-band configuration includes a second guard-band.

13. The method of claim 11 wherein the updated SBFD configuration is received via one of a MAC CE or a DCI message.

14. A wireless transmit receive unit (WTRU) comprising:
a processor; and
a transceiver operably coupled to the processor, the processor and the transceiver operate to:
receive a duplexing sub-band full duplex (SBFD) configuration information from a serving cell, the SBFD configuration information including a guard-band configuration associated with cross link interference (CLI) measurements, and a CLI threshold;
determine that a measured CLI exceeds the CLI threshold;
based on the determination that the measured CLI exceeds the CLI threshold, determine a set of resource blocks (RBs) to use as a first guard-band;
perform an uplink (UL) transmission comprising the first guard-band by puncturing the determined set of RBs, wherein the UL transmission comprises reporting information on at least one of the punctured determined set of RBs used as the first guard band and the measured CLI; and
receive an indication from a network acknowledging the reporting information.

15. The WTRU of claim 14 wherein the SBFD configuration information is based on a capability of the WTRU and includes CLI measurement configuration information and a reporting configuration.

16. The WTRU of claim 14 wherein the guard-band configuration associated with CLI measurements comprises at least one of a trigger associated with the CLI threshold, a guard-band granularity value, and an indication to perform partial transmissions overlapping the set of RBs to use as a first guard-band.

17. The WTRU of claim 14 wherein the processor and the transceiver further operate to receive a resource allocation for transmissions.

18. The WTRU of claim 17 wherein the resource allocation for transmissions includes an UL periodic grant method comprising at least one of radio resource control (RRC) reconfiguration, medium access control (MAC) control element (CE) activation or downlink control information (DCI).

19. The WTRU of claim 14 wherein determining a set of RBs to use as the guard-band includes a size and a position of the guard-band corresponding to one or more RBs of the set of RBs exceeding the CLI threshold.

20. The WTRU of claim 14 wherein an updated SBFD sub-band configuration includes a second guard-band and is received via one of a MAC and a DCI message.
